(19) United States
(12) Patent Application Publication
(10) Pub. No.: US 2018/0136837 A1
(43) Pub. Date: May 17, 2018

(54) ADVANCED VIRTUAL KEYBOARD

(71) Applicant: Donald Butler Curchod, Avalon Nsw (AU)

(72) Inventor: Donald Butler Curchod, Avalon Nsw (AU)

(21) Appl. No.: 15/816,658

(22) Filed: Nov. 17, 2017

Related U.S. Application Data
(60) Provisional application No. 62/438,428, filed on Dec. 22, 2016.
(60) Provisional application No. 62/426,037, filed on Nov. 23, 2016.
(60) Provisional application No. 62/423,596, filed on Nov. 17, 2016.

(51) Int. Cl. G06F 3/0488; G06F 3/0481; G06F 3/023

(52) U.S. Cl. CPC G06F 3/04886; G06F 3/0236; G06F 3/0481

(57) ABSTRACT

A virtual keyboard is configured to display, at a display device, keys having primary, secondary, or tertiary elements. These elements are selected through one or more clicks on the key. In response to the number of received clicks, the element is entered as text or images in an application in communication with the virtual keyboard. Also, in response to user input, a prompt area on the display device is populated with text or images that can also be selected instead of elements on the keys. The keys and prompt area can be distributed on a single computing device or across multiple computing devices.

### RELATED APPLICATIONS

This disclosure claims priority, under 35 U.S.C. § 119 , to U.S. Provisional Patent Application Ser. No. 62/423,596, entitled “Advanced Virtual Keyboard” and filed on Nov. 17, 2016; U.S. Provisional Patent Application Ser. No. 62/426,037, entitled “Advanced Computer Prompt System And Method” and filed Nov. 23, 2016; and U.S. Provisional Patent Application Ser. No. 62/438,428, entitled “Advanced Virtual Keyboard” and filed Dec. 22, 2016. The entire contents of the above-referred patent applications are incorporated by reference herein.

### TECHNICAL FIELD

The subject matter described herein relates to systems, methods and computer programs for graphical user interfaces on touch-screen devices.

### BACKGROUND

Touch-screen devices, such as smartphones, tablet computer, smartwatches, or the like, can receive user input through a touch-screen based on the measuring of a resistance or capacitance at a point of interaction. Some devices include a keyboard overlay on the touch-screen to associate a touch at a certain location as being equivalent to a key press as if using a physical keyboard.

### SUMMARY

In one aspect, a keyboard is described that includes a plurality of keys and a prompt area. At least one key of the plurality of keys can include a primary element and a secondary element of a plurality of elements. The prompt area can display one or more characters associated with at least one element of the plurality of elements.

In some variations, one or more of the following can be implemented either individually or in any feasible combination. The at least one key can further include a tertiary element of the plurality of elements. The at least one key can further include one or more additional elements of the plurality of elements.

Each element of the plurality of elements can be input when a corresponding action specific to the element is performed on the at least one key. The corresponding action can be one or more of: a single click of the at least one key, a double click of the at least one key within a preset time-period, a triple click of the at least one key within another preset time-period, a simultaneous click of the at least one key and a shift key within the plurality of keys, a pressing of the at least one key for more than a preset amount of time, a swipe over the at least one key in any direction, a swipe over the at least one key in a preset direction, a click on a specific portion of a trackpad communicatively coupled to the keyboard, and a selection on an input device communicatively coupled to the keyboard.

The corresponding action can be dependent on an amount of physical area occupied by the at least one key. The one or more characters can be displayed in the prompt area differ based on a speed of the corresponding action. The corresponding action specific to the element can be changeable.

The secondary element can be a word that begins with the primary element. A textual characterization of the secondary element can begin with the primary element. The one or more characters displayed in the prompt area can include a plural of the word when the word is singular, and a singular of the word when the word is plural. The one or more characters displayed in the prompt area can include one or more alternates to the secondary element. The one or more characters displayed in the prompt area can include at least one character preselected by a user as at least one favorite character. The plurality of characters displayed in the prompt area can include at least one of: one or more words, one of more phrases, one or more sentences, one or more symbols, one or more icons, and one or more pictographs of faces, objects, and symbols. The one or more icons can include one or more emoticons. The one or more pictographs can include one or more emojis. The keyboard can be a part of one of: a watch, a phone, a phablet computer, a tablet computer, a laptop computer, and a desktop computer.

The prompt area can display the one or more characters in one or more rows. The one or more rows are two or more rows. The one or more characters displayed in the prompt area can include: a word specific to the at least one element, and endings for the word to create at least one of a verb, an adjective, and another derivative of the word. An active area of at least some frequently used keys of the plurality of keys can be larger than active area of other keys of the plurality of keys. The at least some frequently used keys can be preset keys that can include a space key. The prompt area can generate a notification when a typographical error occurs. The notification can include one or more of: a first flash in the prompt area highlighting a location of the typographical error, a second flash in the prompt area, an alarm, and a pop-up window.

In another aspect, a system can include a keyboard, a memory, and a microcontroller. The keyboard can include a plurality of keys and a prompt area. At least one key of the plurality of keys can include a plurality of elements. Each element of the plurality of elements can be input when a corresponding preset action of a plurality of actions is performed by a user. The prompt area can be configured to display one or more characters related to the element of a plurality of characters. The memory can be communicatively coupled to the keyboard. The memory can be configured to store a mapping between the plurality of elements along with the plurality of actions and the plurality of characters. The microcontroller can be communicatively coupled to the keyboard and the memory. The microcontroller can be configured to: receive, from the keyboard, data characterizing an action performed by the user and an identification of a key on which the action is performed; identify, based on the mapping, the one or more characters that are to be displayed on the prompt area; and transmit, to the prompt area, the one or more characters.

In some variations, one or more of the following can be implemented either individually or in any feasible combination. The system can further include an output device that outputs the element input by the corresponding preset action by the user. The output device can be a graphical user interface configured to display the element. The memory can be configured to store a mapping of a plurality of abbreviations and a full word or phrase of each abbreviation. The output device can be configured to output the full word or phrase of a specific abbreviation of the plurality of abbreviations when a user performs another corresponding action on keys corresponding to characters in the specific abbreviation.

The corresponding action can be one of: a single click, a double click within a preset time-period, a triple click within another preset time-period, a simultaneous click with a shift key within the plurality of keys, a pressing of the key for more than a preset amount of time, a swipe over the key in any direction, a swipe over the key in a preset direction, a click on a specific portion of a trackpad communicatively coupled to the keyboard, and a selection on an input device communicatively coupled to the keyboard.

The memory, the microcontroller, and the keyboard can be embedded within a single device having a single physical housing. The memory can be communicatively coupled to the keyboard via a first communication network. The microcontroller can be communicatively coupled to the keyboard via a second communication network. The microcontroller can be communicatively coupled to the memory via a third communication network. A single key can be used for the space and enter functionalities. The keyboard can include a plurality of rows with letters as a primary character. Each row of the plurality of rows with letters as the primary character can have nine or less number of keys to maximize the key spacing in order to avoid typographical errors.

The graphical user interface can display the element when the element is input by the corresponding preset action (e.g., when a key is pressed or clicked) by the user, rather than waiting for an end of the action (e.g., lifting of a finger by the user from a key including the element).

The microcontroller can be configured to display anywhere a pop-up window displaying the one or more characters related to the element. The element can be an emoji.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also contemplated that may include one or more processors and one or more memories coupled to the one or more processors. A memory, which can include a computer-readable storage medium, may include, encode, store, or the like, one or more programs that cause one or more processors to perform one or more of the operations described herein. Computer implemented methods consistent with one or more implementations of the current subject matter can be implemented by one or more data processors residing in a single computing system or across multiple computing systems. Such multiple computing systems can be connected and can exchange data and/or commands or other instructions or the like via one or more connections, including but not limited to a connection over a network (e.g., the internet, a wireless wide area network, a local area network, a wide area network, a wired network, or the like), via a direct connection between one or more of the multiple computing systems, etc.

### BRIEF DESCRIPTION OF THE DRAWINGS

FIG. 1 is a diagram illustrating a simplified view of an exemplary keyboard, in accordance with certain aspects of the present disclosure;

FIG. 2 is a diagram illustrating a simplified view of exemplary keys from the keyboard incorporating exemplary primary, secondary, and tertiary elements, in accordance with certain aspects of the present disclosure;

FIG. 3 is a diagram illustrating a simplified view of an exemplary prompt area displaying additional elements, in accordance with certain aspects of the present disclosure;

FIG. 4 is a diagram illustrating a simplified view of an exemplary mapping between keys on the keyboard and additional elements displayed in the prompt area, in accordance with certain aspects of the present disclosure; and

FIG. 5 is a diagram illustrating a simplified view of a second exemplary keyboard including the prompt area, in accordance with certain aspects of the present disclosure;

FIG. 6 is a diagram illustrating a simplified view of a third exemplary keyboard including prompt words in the prompt area, in accordance with certain aspects of the present disclosure;

FIG. 7A is a diagram illustrating a simplified view of a fourth exemplary keyboard including icons in the prompt area, in accordance with certain aspects of the present disclosure;

FIG. 7B is a diagram illustrating a simplified view of an editable emoji list, in accordance with certain aspects of the present disclosure;

FIG. 8 is a diagram illustrating a simplified view of a fifth exemplary keyboard 800 including both icons and secondary elements, in accordance with certain aspects of the present disclosure;

FIG. 9 is a diagram illustrating a simplified view of a sixth exemplary keyboard including index keys, in accordance with certain aspects of the present disclosure;

FIG. 10 is a diagram illustrating a simplified view of a seventh exemplary keyboard including a symbol row, in accordance with certain aspects of the present disclosure;

FIG. 11 is a diagram illustrating a simplified view of a eighth exemplary keyboard with larger keys, in accordance with certain aspects of the present disclosure;

FIG. 12 is a diagram illustrating a simplified view of a secondary device used to display the prompt area, in accordance with certain aspects of the present disclosure;

FIG. 13 is a diagram illustrating a simplified view of a secondary device as a mouse incorporating a touch screen, in accordance with certain aspects of the present disclosure;

FIG. 14 is a diagram illustrating a simplified view of a secondary device as a smartphone or tablet incorporating a touch screen, in accordance with certain aspects of the present disclosure;

FIG. 15 is a diagram illustrating a simplified view of an exemplary system with a custom keyboard input manager running on a mobile computing device, in accordance with certain aspects of the present disclosure;

FIG. 16A is a diagram illustrating a computer with a prompt area that conforms to the dimensions of a track pad on the computer, in accordance with certain aspects of the present disclosure;

FIG. 16B is a diagram illustrating a mouse that can select prompts displayed on the screen, in accordance with certain aspects of the present disclosure;

FIG. 16C is a diagram illustrating a computer with a prompt area that is proportional to the dimensions of a track pad on the computer, in accordance with certain aspects of the present disclosure;

FIG. 16D is a diagram illustrating a display including three prompts, in accordance with certain aspects of the present disclosure;

FIG. 16E is a diagram illustrating a keyboard of a computing system, such as a desktop computer, a laptop computer, a tablet computer, a phablet computer, a smartphone, or any other computing device, in accordance with certain aspects of the present disclosure;

FIG. 17A is a diagram illustrating a computer with a prompt area that includes a reference to the key which triggers the prompt, in accordance with certain aspects of the present disclosure;

FIG. 17B is a diagram illustrating a first example of a prompt area, in accordance with certain aspects of the present disclosure;

FIG. 17C is a diagram illustrating a second example of a prompt area, in accordance with certain aspects of the present disclosure;

FIG. 17D is a diagram illustrating a third example of a prompt area, in accordance with certain aspects of the present disclosure;

FIG. 18A is a diagram illustrating a virtual keyboard with a multiple prompt area, in accordance with certain aspects of the present disclosure;

FIG. 18B is a diagram illustrating a virtual keyboard with an alternate prompt row, in accordance with certain aspects of the present disclosure;

FIG. 19 illustrates one view of a keyboard, in accordance with certain aspects of the present disclosure;

FIG. 19A illustrates an alternative prompt key row of the keyboard, in accordance with certain aspects of the present disclosure;

FIG. 19B illustrates another alternative prompt key row with a key on the left, in accordance with certain aspects of the present disclosure;

FIG. 20 illustrates a prompt keyboard including prompt key and prompt word, in accordance with certain aspects of the present disclosure;

FIG. 20A illustrates an alternative to the space bar/key that can have additional symbols, in accordance with certain aspects of the present disclosure;

FIG. 20B illustrates a lower section of a smart phone keyboard, specifically lower row, with back key in place of the return key of FIG. 20 in order to advantageously include an extra key, in accordance with certain aspects of the present disclosure;

FIG. 21 illustrates a lower section of a smart phone, in accordance with certain aspects of the present disclosure;

FIG. 21A illustrates a smart phone keyboard with uniform vertical separation between lower rows, in accordance with certain aspects of the present disclosure;

FIG. 21B illustrates another smart phone lower keyboard, in accordance with certain aspects of the present disclosure; and

FIG. 22 illustrates two rows of a compact smart phone or tablet keyboard, in accordance with certain aspects of the present disclosure.

Like reference symbols in the various drawings indicate like elements.

### DETAILED DESCRIPTION

The present disclosure describes systems, methods, and computer program products allowing for, among other things, rapid and efficient entry of user selected data in applications that employ keyboard-based interfaces. The features described herein improve the efficiency of data entry on devices especially where the screen size and/or number of options for a keyboard interface are limited. In particular, by utilizing detection of multiple click events, and/or a swiping action by a user, on a single keyboard key, or prompt, other typing elements can be displayed and selected. This can enable effectively having multiple keyboards worth of characters accessible from a single keyboard display. As such, the present disclosure, among other things, improves a fundamental operation of modern mobile computing systems, for example, the ability of user to enter or select information on a touch-screen display. The user can also be referred to as an operator.

As used herein, the term “element” can refer to, for example, characters, strings, symbols, icons or images, functions, or the like, associated with a particular key. Characters can include, for example, letters, numbers, symbols, or the like. Any of the characters, symbols, and other keyboard elements can be in any language, for example, Asian languages, Arabic languages, foreign accent characters, or the like.

As used herein, the term “click” can refer to, for example, the act, or data/electrical signals derived from the act, of a user selecting a key or other portion of the keyboard or area of the touch-screen with a brief tap. The click can indicate a desired element, character, or function enabled by the present disclosure or accessible through the keyboard. A click can include, for example, pressing, tapping, selecting with a stylus, clicking a mouse and/or physical button associated with a computing system, or any similar method of selecting an element on a keyboard or screen. A click can also include initiating the transmitting/receiving of data indicating information about the click. The data can include, for example, the location, time, pressure, duration, or the like, of the click. In some implementations, the functionality enabled by the click can be additionally or alternately be enabled by a swipe of a key and/or prompt, which can enhance the capability and operation of the keyboard.

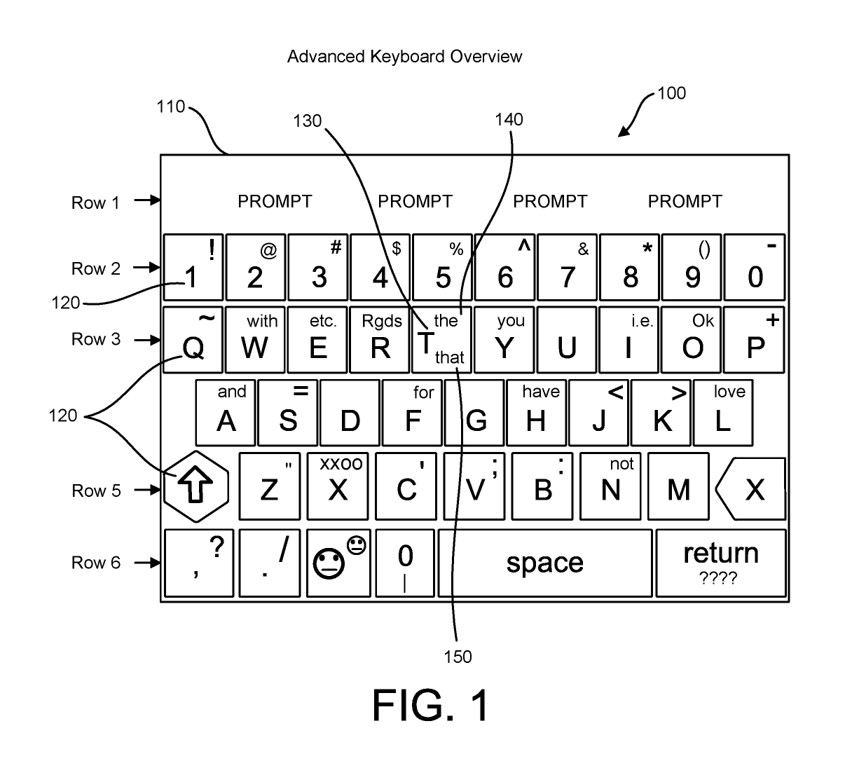

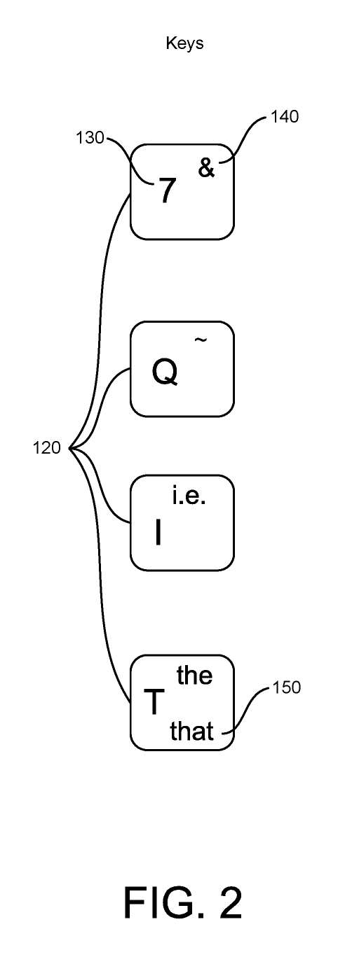

FIG. 1 illustrates an exemplary keyboard 100 in accordance with certain aspects of the present disclosure. FIG. 2 illustrates exemplary keys 120 from the keyboard 100 incorporating exemplary primary 130, secondary 140, and tertiary elements 150 in accordance with certain aspects of the present disclosure. As part of a program application, or by a specific application herein described as a custom keyboard input manager, a keyboard 100 can be graphically projected onto a touch-screen of a device display for a computing device. The touch-screen can be, for example, the screen of a smartphone, smartwatch, tablet computer, or the like. The computing device can detect contact at the touch screen and generate commands based on the type and/or location of the contact. The device display can include the touch-screen, but can also include portions of the computing device that can display images but may not be able to detect contacts in the manner of the touch-screen. Also, a number of the enclosed features can also be applied to a standard, non-touch-screen keyboard.

The custom keyboard input manager (or any other suitable application) can interpret the click as a selected user input based on where the click was made on the touch-screen. In some implementations, the custom keyboard input manager can be executed on the computing device. The custom keyboard input manager can be a software application. In an alternate implementation, the custom keyboard input manager can include hardware, which can include one or more processors and/or a storage structure, which can be random access memory and/or read only memory. In other implementations, the custom keyboard input manager can be stored and executed on a remote computing system, for example a server connected to the computing device by a network connection. The location and timing of the contacts at the touch-screen can be transmitted by the computing device to the remote custom keyboard input manager. The contacts can then be interpreted as described herein, and commands transmitted back from the server to the computing device for displaying the keyboard layouts.

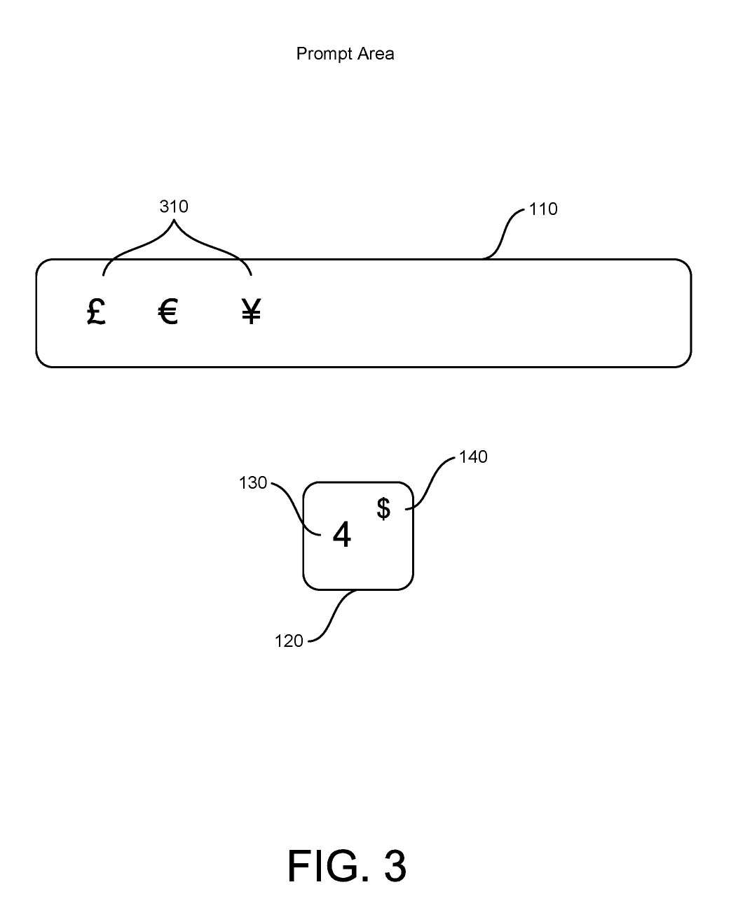

The custom keyboard input manager can also generate and display a prompt area 110 on the device display. The prompt area 110 can display images that can be selected by a user. As described in further detail below with reference to FIG. 3, the prompt area 110 can display elements based on a user clicking a key 120.

The keyboard 100, as shown for example in FIG. 1, can include any number or graphical configuration of keys 120 that can be clicked by a user through the touch-screen. A key 120 can include a primary element 130, for example, “A,” “S,” “D,” or the like. The key 120 can also include representations of symbols, for example, a smiley face for emojis or icons, an up-arrow indicting a shift operation, or the like. The key can also perform a function, and such a key can be, for example, a backspace key (e.g., the “X” key at the extreme right of Row 5), a shift key (e.g., the “↑” key) that toggles between upper and lower case characters, a microphone key to activate a microphone of the computing device, a camera key to activate a camera of the computing device, or the like.

Many of the keys 120 shown in FIG. 1 include not just the primary element 130 but also can include one or more other characters or strings. As used herein, when the key has only two elements, for example the “1,” “Q,” or “C” keys 120, then the key can be referred to as containing a primary element 130 and a secondary element 140. In the case of the “Q” key, the primary element 130 is the character “Q” and the secondary element 140 is the “˜.” Similarly, when the key has three elements, then the third element can be referred to as a tertiary element 150. For example, the “T” key has can have character “T” as a primary element 130, the string “the” as a secondary element 140, and the string “that” as the tertiary element 150. Although only a maximum of three elements are shown on a single key 120, there can be any number of elements displayed on and accessible by a given key 120. The selections and configurations shown in FIG. 1 of the keys 120, primary elements 130, secondary elements 140, and tertiary elements 150, can be varied to include any combination of characters, symbols, strings, functions, or the like.

The keyboard 100 can allow a user to select input based on the number of times a key is clicked and/or swiped. In some implementations, the custom keyboard input manager can determine the number of clicks received at the keyboard 100. In other implementations, the number of clicks received can be determined by another program and transmitted to, or read by, the custom keyboard input manager. When two clicks are received in a specified time interval, they can be identified as a “double-click.” The double-click can be interpreted by the custom keyboard input manager as indicating a different user input than just a single click. Similarly, three clicks can be a “triple-click,” and so on.

In implementations implementing the swiping functionality, the keyboard can detect a swipe, and such a detection can be in addition detection of a click.

The above double click, to automatically input a word or series of words, including a space, can be based on the speed of clicking. Since this can vary from user to user, a more robust method can be to only have the word or series of words appear if the double click of the first letter of a word is used only after a space. Rare words such as “Aaron” can be accomplished by slow double tapping or having “Aaron” appear as a prompt. A prompt can be a suggestion displayed in a prompt area, which can be a graphical user interface implemented on the keyboard 100. Pausing after the first letter after a space can also be used as an alternative, or as well as, to input the word or series of words. The word or series of words associated with this first letter of a word can also be held in memory and be available for editing.

In some implementations, the custom keyboard input manager can be configured to distinguish between a double-click and a double-letter (such as when typing “Aaron”) by interpreting the delay between the successive clicks of a key 120. When the delay is longer than a specified time period, for example, 0.1, 0.25, 0.5, or 1 second, the successive clicks can be interpreted as two single clicks and not as a double-click. Other delays in multiples of hundredths, tenths, or whole numbers of seconds, can also be implemented to distinguish between double-clicks, triple-clicks, or the like, and normal typing clicks to enter the primary element 130 of the corresponding key 120.

With regard to letter rows as in 130 of FIG. 1, in order to remove possible errors from multiple clicks, a letter key may be double clicked only after a space in order for the secondary element 140 string or character to be entered, i.e. as in the word ‘the’ of key 130 in FIG. 1. The secondary elements 140 (for example ‘the’) associated with a letter can be held in operator editable memory. These words 140 can be full words, abbreviations, or any desired character strings. It should be noted that the above could also be achieved by a short pause (e.g. pressing and holding the key) when selecting the letter. For example, pausing at the letter ‘T’ 130 could cause ‘the’ 140 held in editable memory to be entered. Also held in operator editable memory can be shorthand words such that typing Bjj, or Brjj i.e. typing b (or B and r), then double clicking j results in ‘Best Regards John Smith’ being displayed and entered in the text. For this feature, an operator editable list of key shorthand abbreviations, together with the editable text to be entered, is held in memory. The above can cause the appropriate text to be entered by matching the stored shorthand key strokes. In this way an almost unlimited and speedy method of typing can be achieved. In similar fashion to the above, such shorthand words can also be entered (instead of double clicking) by pausing briefly at the last letter of the shorthand code. These shorthand code word abbreviations can be held in operator editable memory. The memory as noted herein can be random access memory (RAM), read only memory (ROM), a database (which can be a table in one implementation), and/or the like.

Each element on a key 120 can be associated with a single click, a double-click, a triple-click, any other number of clicks, and/or one or more swipes of one or more keys. In one implementation, the direction of a swipe can be used to input different elements. When the number of clicks, type of click (e.g., single, double, triple, or any other number), and/or type of swipe (e.g., swipe to the left, swipe to the right, or the like) has been determined, an element associated with the key 120 can be assigned as selected user input. A similar result can also be achieved by pressing and holding a key in order to select the secondary element 140. For example, referring to FIG. 2, the primary element 130 can be the “7” and the secondary element 140 can be the “&”. Here, when a user single-clicks the key, this can be interpreted as selecting the “7” for the user input. Similarly, when the user double-clicks the key, this can be interpreted as selecting the “&” for the user input. Once the user input is selected, it can be transmitted to the program that has interfaced with the keyboard 100 and is configured to receive the selected user input. The “Q” key in FIG. 2 can perform similarly to the example given above. The “I” key in FIG. 2 shows a string “i.e.” as the secondary element 140. The “T” key in FIG. 2 has the letter “T” as a primary element 130, “the” as a secondary element 140, and “that” as a tertiary element 150. As before, “T” and “the” can be selected based on detecting one or two clicks, respectively. The tertiary element 150 “that” can be selected based on detecting three clicks. From the above description, it can be seen that any number of elements can be included on a key. Each of any number or type of elements can be assigned as a selected user input based on the determined number of clicks.

Once the selected user input is determined, it can be transmitted, by the custom keyboard input manager, to a program configured to receive the selected user input. In this way, the custom keyboard input manager can be run concurrently as an augmentation to another program, such as a web-browser program, messaging program, word processing program, any other program, and/or any combination thereof.

The custom keyboard input manager can also include auto-spacing as part of the transmission, or auto-spacing can be implemented by the receiving program. Auto-spacing can include automatically adding one or more spaces to following a character or string displayed on the device display.

FIG. 3 illustrates an exemplary prompt area 110 displaying additional elements in accordance with certain aspects of the present disclosure. When a key 120 is pressed, clicked, double-clicked, or the like, additional elements can be generated and displayed in the prompt area 110. The prompt area 110 can be within the touch-screen and be able to receive user input clicking or selecting one or more of the additional elements. The selected additional element can then be assigned as the selected user input. As shown in the example of FIG. 3, the “4” key has a secondary element 140 “$.” As this is a common symbol for currency, the prompt area 110 can display other symbols for currency that a user may wish to select instead.

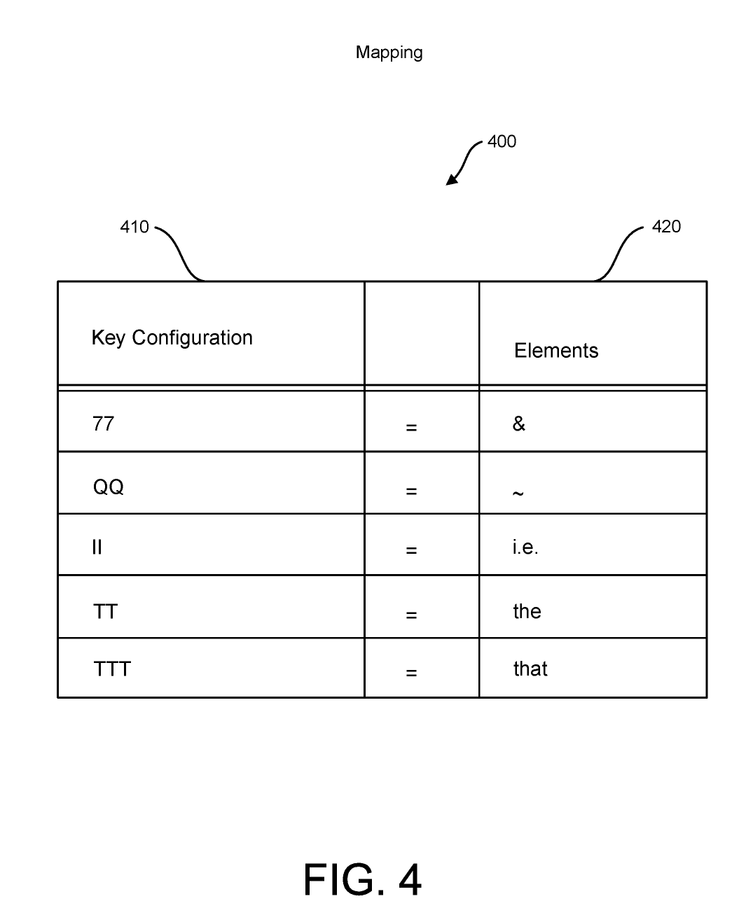

FIG. 4 is a diagram illustrating a simplified view of an exemplary mapping in accordance with certain aspects of the present disclosure. The configuration of the keyboard 100 and additional elements displayed in the prompt area 110 can be stored in a mapping 400 accessible by the custom keyboard input manager. The mapping 400 can be a table that associates the key 120 and a specified number of clicks, to a primary element 130, secondary element 140, tertiary element 150, or additional element. The mapping 400 can be a table, a portion of which is shown in the example of FIG. 4. The mapping 400 shown in FIG. 4 also corresponds to the keys 120 shown in FIG. 2. In some implementations, the mapping 400 can include a key configuration 410 and an elements configuration 420. The key configuration 410 can be a listing of keys and an indication as to a type of interaction with that key 120, such as a single-click, double-click, triple-click, any other number of clicks, a swipe, a particular type of swipe, or the like. The elements configuration 420 can assign an element (primary, secondary, tertiary, or the like) as corresponding to a particular type of key input. For example, the first row of the mapping 400 shows that the “7” key can have “&” as a secondary element 140. Similarly, the “T” key can have “the” or “that” as a secondary element 140 or a tertiary element 150. In some implementations, the primary element 130 can be stored as a doubled or trebled character, to associate a double-click with one table entry and a triple-click with another, or a swipe with yet another. In the example of FIG. 4, the “TT” entry associates a double-click of the “T” key with “the” and the “TTT” entry associates a triple-click of the “T” key with “that.”

The mapping 400 can be displayed in a user-modifiable format when the custom keyboard input manager detects a specific pre-defined user input, for example, double-clicking a return key, or the like. The mapping 400 can be generated on the device display for modification by the user. The user can select keys 120 and characters that can be added to the mapping 400. To select keys and elements used in the mapping, selecting a field in the mapping can cause a word symbol list to be displayed. The word symbol list can include any number of characters, symbols, strings, images, icons, emojis, or the like. The user can select from the word symbol list to alter the mapping. In other implementations, the mapping 400 can be a file downloaded from another computing system or from another program on the mobile device.

There can also be a secondary mapping that can include the additional elements 310 to be displayed in the prompt area 110. Like the mapping 400, the secondary mapping 400 can also be modifiable by a user. In some implementations, the mapping 400 and the secondary mapping 400 can be part of the same mapping 400, for example, being part of a single table.

In another implementation, the custom keyboard input manager can interpret one or more clicks, presses, or character choices as a shorthand entry to be expanded into a pre-defined typing selection. For example, clicking “b” then “r” then “a” then a “space,” can be interpreted as “Best Regards, Andrew.” The appropriate text can then be displayed in the typing field of the computing device. The interpretation of shorthand typing options can be stored and modified by a user in a manner similar to the mapping 400.

“Best Regards Andrew” with a space after “Andrew,” can also be similarly achieved by pressing “Baa” (without a space) if the shorthand entry “Baa” or “baa” is being held in memory as corresponding to “Best Regards Andrew” with a space. In this way, the shorthand entry, which can be user-editable or hardcoded into the computer memory or program, can add space (or any other characters) after the desired text string.

Any code word with the last letter double tapped to match a shorthand entry in memory can also be used for this operator editable shorthand system.

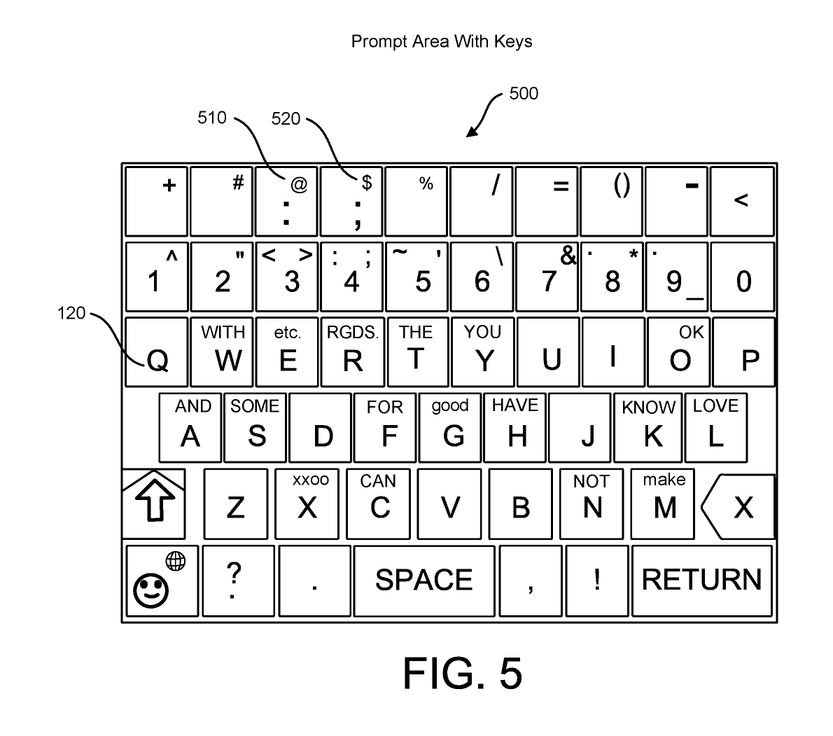

FIG. 5 is a diagram illustrating a simplified view of a second exemplary keyboard 500 including the prompt area, in accordance with certain aspects of the present disclosure.

In some implementations, the detection of a double-click, triple-click, or the like, can cause a selection of characters, words, emojis, or the like, to be displayed on the prompt area 110. The keyboard 500 can be configured to respond differently depending on which row receives multiple clicks. In one implementation, row 1 can be a prompt area 110 that displays characters as described, for example with reference to FIG. 3, as well as the additional functionality described below.

Row 2 can have multiple clicking functions disabled. Instead, in some implementations, clicking a key, for example in row 2, can cause the primary element to be entered in the text. At the same time, the prompt area can display the secondary element and/or the tertiary element, or the like. For example, when the “4” key is pressed (having secondary element “:” and tertiary element “;”), a “4” can be entered as the selected text and the prompt area can display a first alternate key 510 with “:” as the primary element and a second alternate key 520 with “;” as the primary element. The first alternate key and the second alternate key can operate similarly to the keys as described herein. When secondary element “:” or tertiary element “;” is clicked, then that element can be selected as the text in place of the “4.” In another example, pressing “shift” and then the “2” key can cause the quote character “”” to be entered in place of the “2.” In this way, the “shift” key performs the same operation as a double-click. In general, any key, such as shift, alt, ctrl, or the like, can be clicked, or pressed and held, to select a secondary element, a tertiary element, or the like.

Also, rows 3-5 can be configured to cause the prompt area 110 to display character options based on the received multiple-clicks at a particular key. Once displayed, the user has the option to click any of the displayed characters in the prompt area 110. For example, double-clicking the “space” key can cause emojis to be displayed on the prompt area 110.

In another implementation, the secondary elements 140, for example those shown in rows 3-5, can be selected based on a double-click that occurs after a space. For example, a user could type “I am,” then add a space after “am.” When the user double-clicks the “W” key, because this is the first entry after the space, the word “with” can be automatically inserted into the text string. This functionality can also be incorporated into any alternate keyboards displayed, for example, when the shift key is clicked, the keyboard 500 can display upper-case letters and symbols in the prompt area 110 instead of numbers. This alternate keyboard 500 can have its own mapping 400 to display secondary elements 140 and prompts while still functioning as described above.

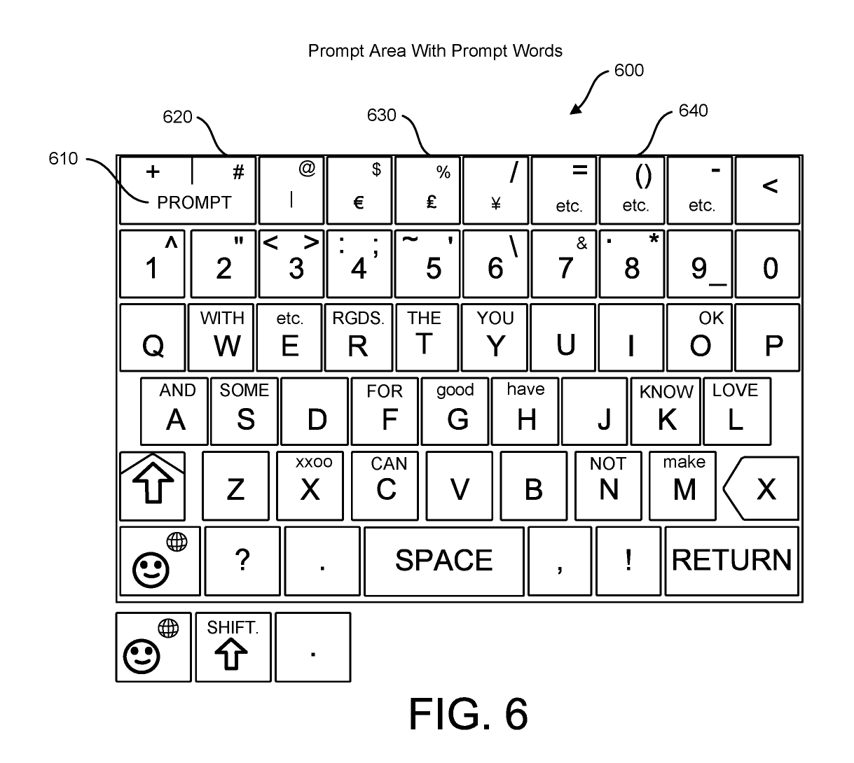

FIG. 6 is a diagram illustrating a simplified view of a third exemplary keyboard 600 including prompt words 610 in the prompt area, in accordance with certain aspects of the present disclosure.

In some implementations, instead of the prompt area displaying a primary element, a section of the prompt area, corresponding to one or more keys in the prompt area, can contain a prompt word. The prompt word can be selected by pressing any key corresponding to the section containing the prompt word. For example, row 1 shows a partitioned prompt row having three sections: a section 620 labelled “prompt 1,” a section 630 with three currency types, and a section 640 with undefined characters. In the section corresponding to the “prompt 1,” there are three keys displayed. The first key has “+” as a secondary element, the second key has “#” as a secondary element, and the third key has “@” as a secondary element. A single click on any of these three keys can select the prompt word. A double click or swipe on any of these keys can select the corresponding secondary element. In other words, in this example, these three keys all have the same primary element—the “prompt word.” The prompt word can be any of the words shown as secondary elements or tertiary elements of other keys on the keyboard, for example, “with” for the “W” key, or the like. In other implementations, other prompt words can be displayed according to a pre-existing configuration or mapping.

In other implementations, the selection of the secondary element in a key in the prompt area can cause one or more primary elements to be displayed in the prompt area. For example, when the key with “$” as a secondary element is double-clicked or swiped, can select “$.” However, this can also cause additional currency options to be displayed as primary elements. In the example shown, double-clicking or swiping the “$” can cause the three alternate currency symbols below to be shown as primary elements in their corresponding three keys. When one of these alternate currency symbols is selected the corresponding primary element can replace the prior selection. For example, if the British pound symbol was clicked after the “$” was clicked, the British pound symbol would replace the “$.” In this way, in some implementations, a prompt row can have, in addition to primary values, secondary or more values that can be selected with double- clicking, triple-clicking, or the like.

In other implementations, a dedicated shift key can be used with all rows by clicking the dedicated shift key and then the appropriate key to input the corresponding secondary element. For example, if the dedicated shift key is clicked, then clicking the “X” key can cause “xxoo” to be selected without having to double click the “X” key.

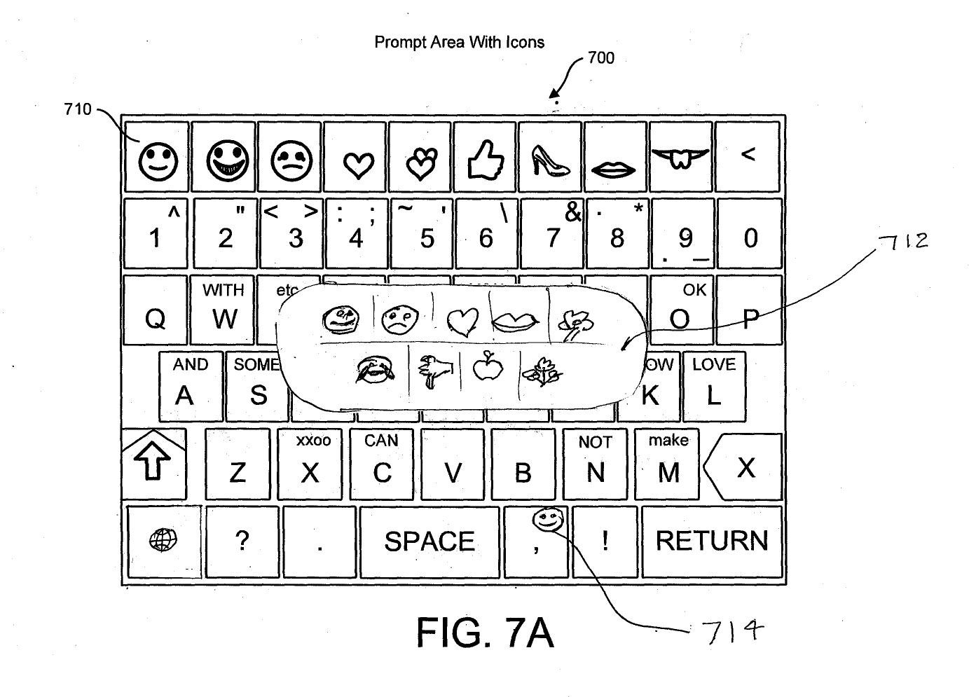

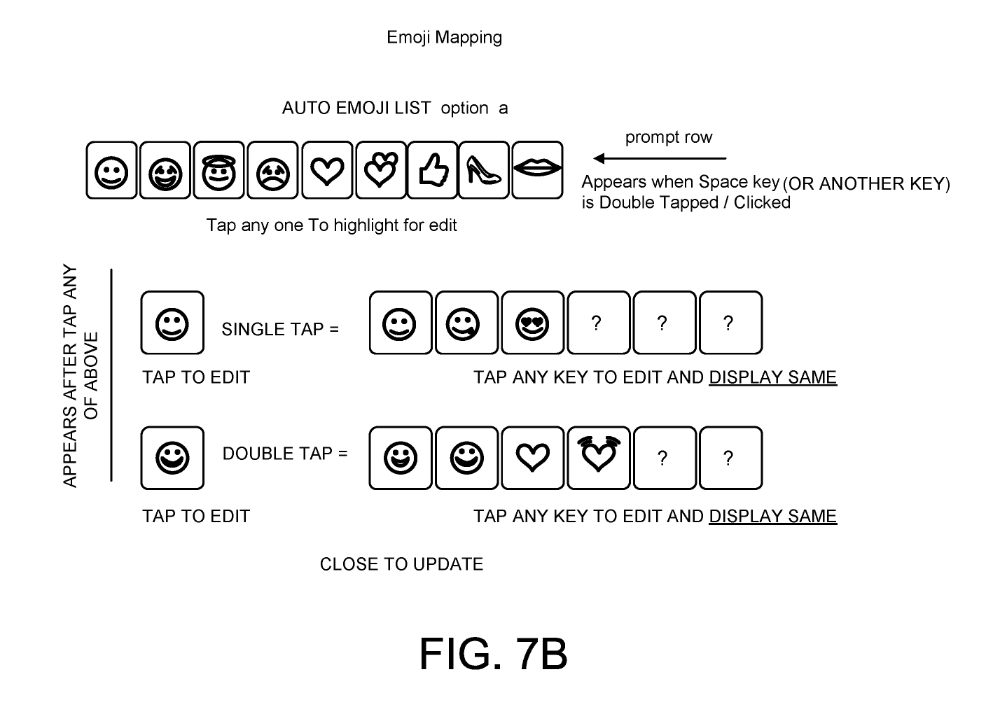

FIG. 7A is a diagram illustrating a simplified view of a fourth exemplary keyboard 700 including icons 710 in the prompt area, in accordance with certain aspects of the present disclosure. Similar to words or characters, the prompt area can also display icons in response to user input. Icons can include emojis, standard icons, or the like. In some implementations, double-clicking a key, for example the space key or any other key or key sequence including pausing, can cause a row of icons to appear in the prompt area. Clicking an icon can cause that icon or any other pre-selected icon, emoji, or series of icons or emojis, to be displayed. Double clicking or swiping an icon can cause an alternate series of multiple icons to appear in the display. Similar to other implementations described herein, the icon represented by a particular key or key sequence can be programmed and stored as part of the mapping, or as another programming definition file. The list or mapping can include which key a particular icon is assigned and the type of input required to display the icon, for example, a click, double-click, swipe or the like.

In an alternate implementation, instead of displaying emojis in the prompt area 710, the emojis can be displayed in the window 712. In another alternate implementation, the window 712 can be displayed in addition to the prompt area 710, both of which can display the emojis. The emojis displayed in the window 712 can be selected and/or edited by an operator or user. This selection and/or editing of the emojis can be performed by a corresponding action by the operator, such as long pressing, double clicking, swiping, or the like, on the key 714 (or another similar key).

FIG. 7B is a diagram illustrating a simplified view of an editable emoji list, in accordance with certain aspects of the present disclosure. The icons or emoji displayed in the prompt area as well as the icons, emoji or emojis displayed in response to a particular key in the prompt area 710 are held in memory and are able to be selected or edited by the operator as shown in FIG. 7B. This can be performed similar to the mapping feature for keys as described herein. A series of icons or emojis can be displayed and a user can tap or otherwise select one of the icons or emojis. The icon or emoji can be displayed along with options that will conform to a single tap, a double tap, pause, swipe, or the like. The options can include a group of other icons and emojis that can be assigned to the specified type of input.

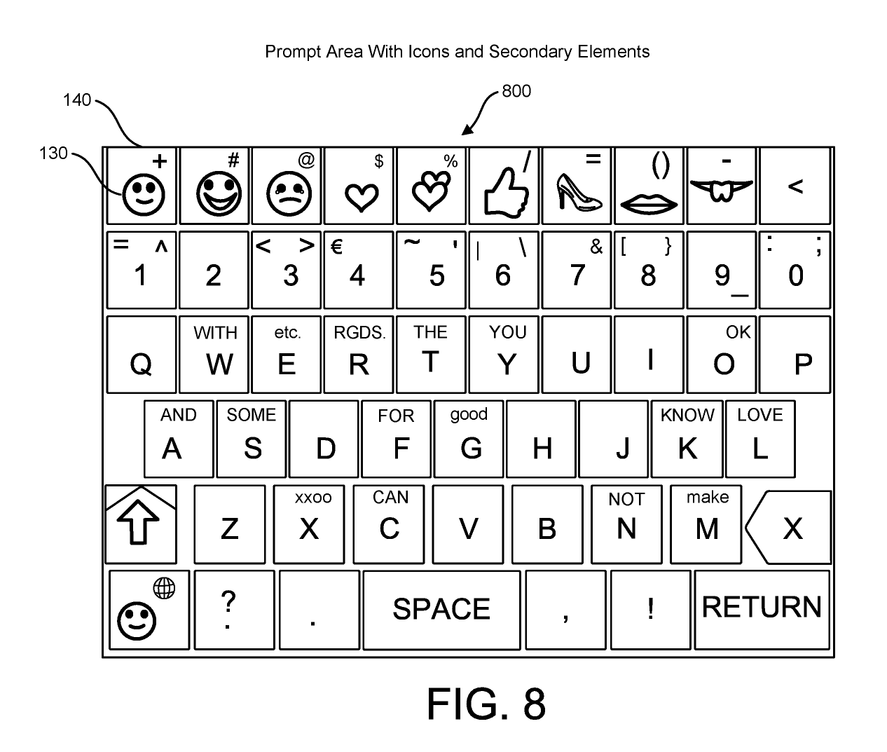

FIG. 8 is a diagram illustrating a simplified view of a fifth exemplary keyboard 800 including both icons and secondary elements, in accordance with certain aspects of the present disclosure. In some implementations, instead of either just icons, or just characters, displayed in the prompt row, both icons and characters (elements) can be displayed. Similar to the functionality described above, for example, a single click can select the icon, a double click or swipe can select an element, and so on. This row of automatic, operator-favorite, emojis can also be programmed to automatically appear when an emoji key is pressed or when the keyboard 800 is used to display the emoji available for use.

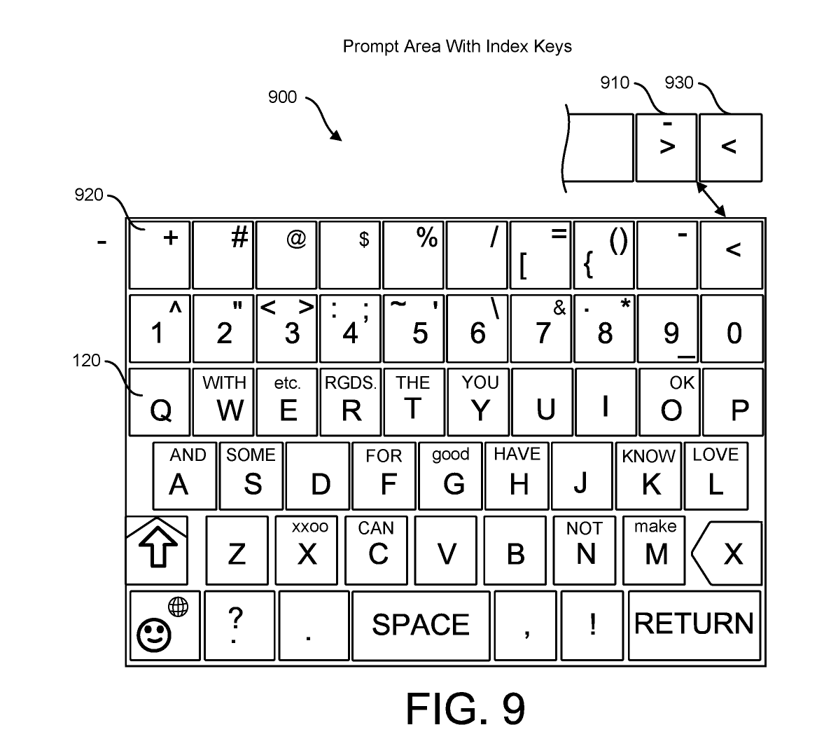

FIG. 9 is a diagram illustrating a simplified view of a sixth exemplary keyboard 900 including index keys 910, in accordance with certain aspects of the present disclosure. In some implementations, clicking or double-clicking, or swiping a key, for example the “{” key shown above the “8” key can also cause different styles of brackets to be displayed as primary elements in the prompt area 920. When the key corresponding to the different style of bracket is clicked, that style of bracket can be selected. In other implementations, pausing between clicks, for more than a specified period of time, can cause the different styles of brackets to be displayed as described above.

In other implementations, there can also be a forward index key 910 and a back index key 930. Any of the keys in the prompt area can have a default configuration (primary element, secondary element, prompt words, etc.). When a forward index key (or the back index key) are clicked, or swiped, one or more keys may toggle to a different setting. For example, a first set of brackets can be displayed in the prompt area. When a forward index key is clicked, a new set of brackets having a different style can be displayed. Clicking the back index key can cause these keys to return to the first set of brackets.

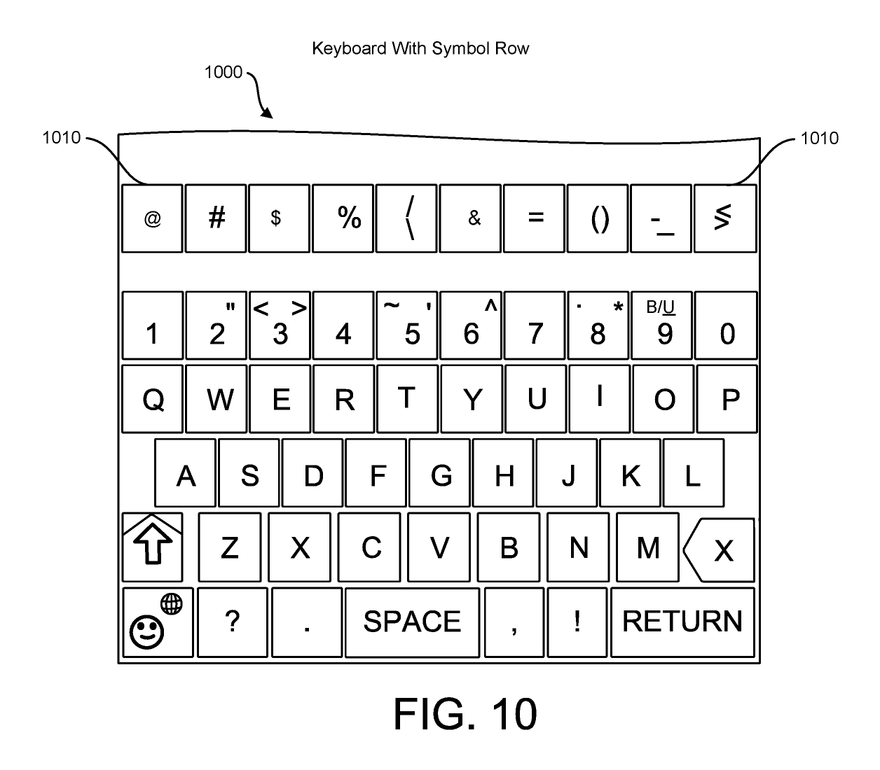

FIG. 10 is a diagram illustrating a simplified view of a seventh exemplary keyboard 1000 including a symbol row 1010, in accordance with certain aspects of the present disclosure. In some implementations, an additional symbol row can be displayed. The symbol row can be displayed either above or below the prompt area. The symbol row can include one or more keys, again having any number of primary, secondary, or tertiary elements, etc. The keys in the symbol row can accept a single click to select the displayed element. In one example, the symbol row can contain any number and type of symbols, for example those shown in FIG. 6.

The selection of a key from a symbol row can cause additional elements to be displayed in the prompt area. These additional elements can be selected as described herein. For example, as shown in FIG. 6 when the “$” is selected, then other currency symbols can be displayed in the prompt area for optional selection by a user. Secondary and tertiary elements from other rows or keys can be displayed in the prompt area for selection. For example, when the “3” keys is clicked, then “<” and “>” can be displayed in the prompt area for selection. In some implementations, there can be one or more index keys 910 that can cause a different set of symbols to be displayed in the symbol row 1010.

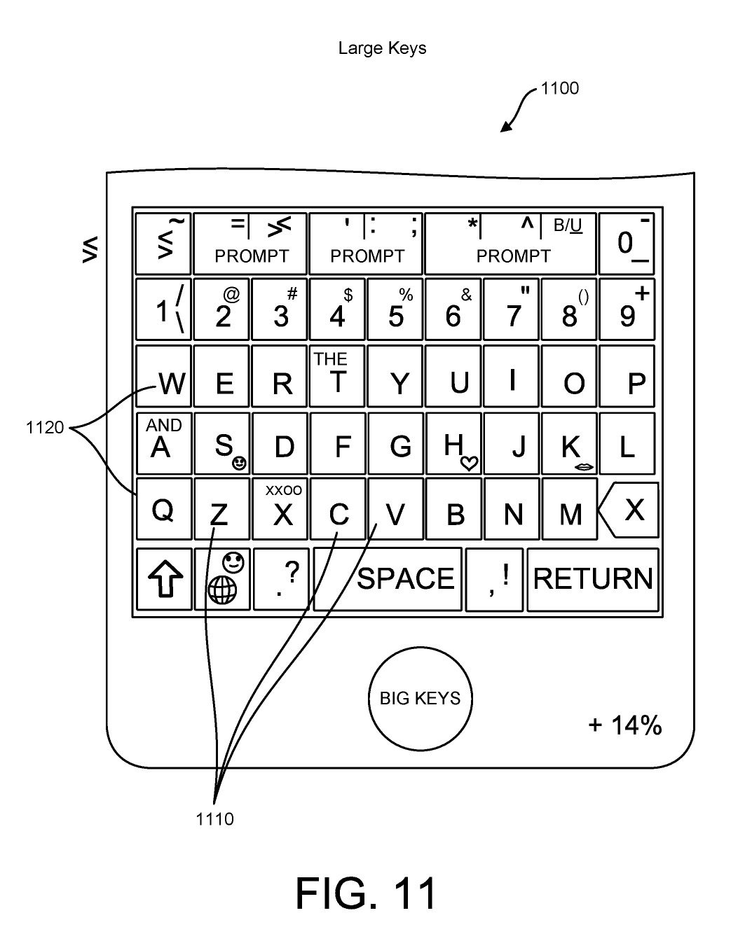

FIG. 11 is a diagram illustrating a simplified view of a eighth exemplary keyboard 1100 with larger keys 1110, in accordance with certain aspects of the present disclosure. The keys displayed on any given keyboard can be re-arranged and resized to enlarge the keys 1110 or make the most room of the limited area available for display. As shown in FIG. 10, the keys 1110 can be expanded in the horizontal direction to make use of formerly wasted space present in some “qwerty” keyboard configurations. In the example of FIG. 11, the “Q” key can be moved from row 3 to row 5 (see FIG. 1 for comparison). Similarly, the “shift” key can be moved from row 5 to row 6. This can enable the remaining keys 1010 to be horizontally larger by about 10%, allowing for increased accuracy when typing. Therefore, by making the number of keys 9 across instead of the standard 10, the minimum key separation can be increased by 10%.

In some implementations, select keys, for example the edge keys 1120, can be narrower than others, allowing other keys, for example more commonly used keys, or central keys, to be proportionally larger. As shown in the example of FIG. 6, the edge keys 1120 can be generated to be slightly thinner, resulting in an increase in width of about 14% for the remaining keys 1110 on those rows.

By also making the edge keys narrower than the center keys, (since the edge keys do not interfere with the edges for entry) this 10% can be increased to 14% thus reducing the wrong key-strike errors prevalent in smart phones. Moving the Q to below the A and placing the) in the prompt area, gives a keyboard which is easier to operate without error as well as keeping the majority of the standard QWERTY key configuration.

In some implementations, the resizing and repositioning of the keys as described can be combined with the multiple-clicking functionality described herein, or can be a stand-alone improvement to an otherwise conventional keyboard program.

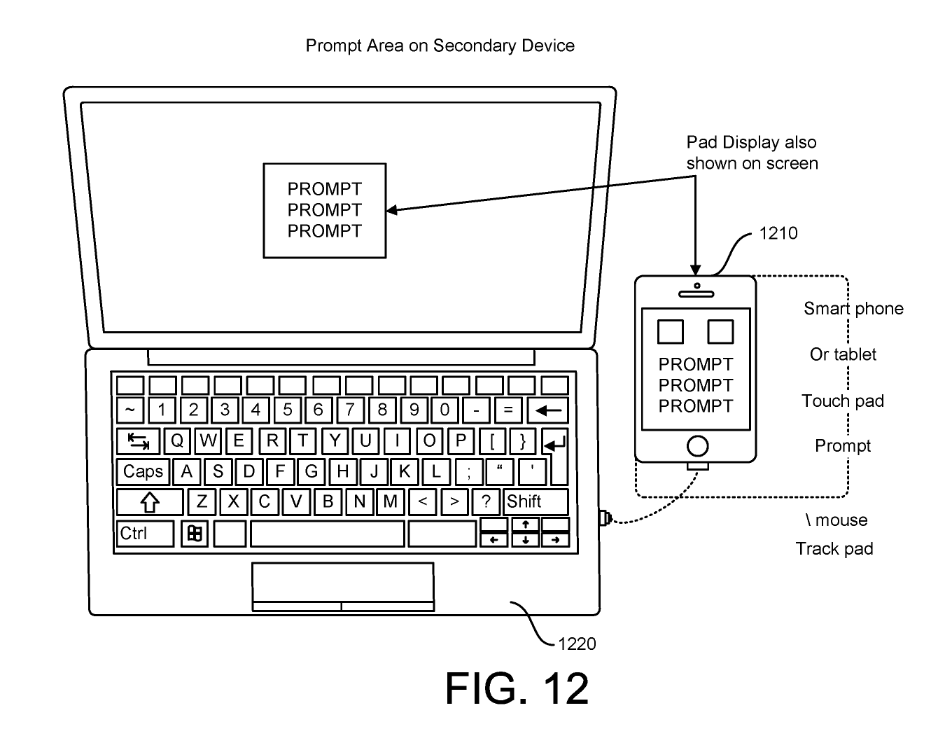

FIG. 12 is a diagram illustrating a simplified view of a secondary device 1210 used to display the prompt area, in accordance with certain aspects of the present disclosure. In some implementations, instead of, or in addition to, displaying the modified keyboard or prompt area entirely on a primary device 1220, for example a desktop computer, laptop, smartphone, or the like, some or all of these features can be displayed on a secondary device. The secondary device can be, for example, a laptop, smartphone, tablet, mouse with touch screen, or the like. The primary device and the secondary device can be coupled wired or wirelessly to be in communication. The custom keyboard management program can be installed on one or both of the primary device and the secondary device.

The secondary device 1210 can be a dedicated smart touch pad, which can operate as a mouse or track pad, including touch prompts, pointer tracking, (by moving the pad or tracing on the surface), sketching on the secondary device, or otherwise coupled to provide any feature common to pads, smart phones, or tablets, or the like. In some implementations, the secondary device can be free, or it can be fixed to the primary device by brackets or swivels, can be wired, and can be wireless.

In some implementations, the prompt area can be displayed on the touch screen of the secondary device 1220. Regardless of which device displays any combination or arrangement of keys and prompt screens, the functionality can be as described herein. For example, a user can be primarily typing on the laptop computer, but have a prompt area open on the secondary device, such as a smartphone. When a desired prompt appears on the prompt area, based on the key selection by the user at the primary device, the user can select the prompt on the secondary device. The secondary device can return the selected prompt, for example, the character, symbol, emoji, sketch, or the like, in the prompt area to the primary device as the user's selection. In this way, additional space can be saved on one or more screens of the devices, keys made larger, among other benefits.

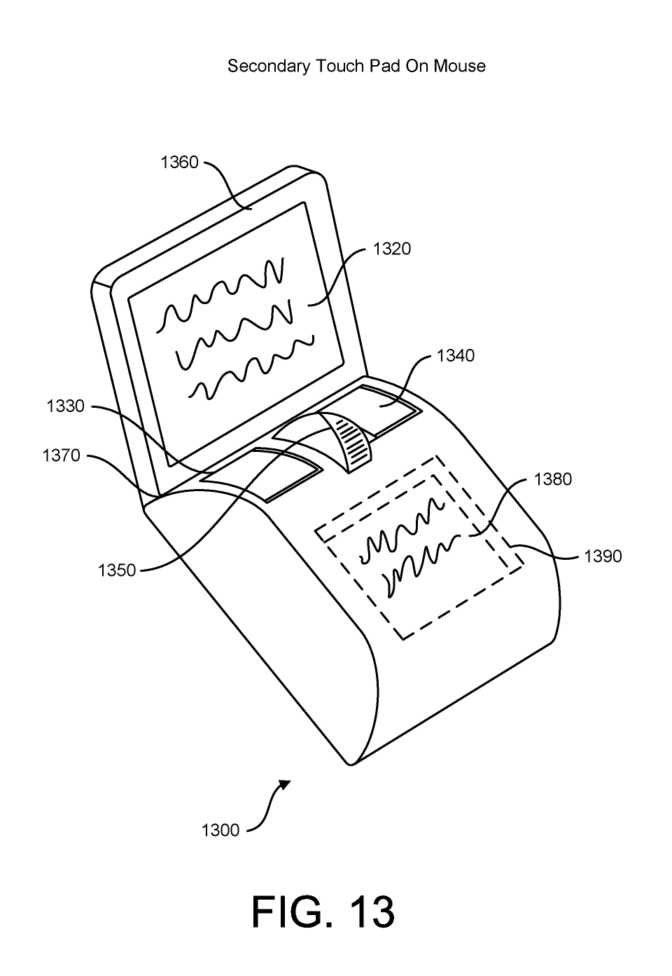

FIG. 13 is a diagram illustrating a simplified view of a secondary device 1300 as a mouse 1310 incorporating a touch screen 1320, in accordance with certain aspects of the present disclosure. As also discussed above with regard to FIG. 12, the secondary device can, among other things, be a device used to provide additional prompt screen space or provide additional functionality. A mouse 1310, as depicted in the example of FIG. 13, can include one or more touch screens that can be used to display prompts, elements, or the like. In some implementations, the mouse 1310 can include a left mouse button 1330, a right mouse button 1340, and a scroll wheel 1350. The left mouse button 1330 and the right mouse button 1340 can each be configured to perform different actions depending on what or where a cursor guided by the mouse 1310 has selected. Similarly, the scroll wheel 1350 can cause graphical output on a screen to scroll, zoom, move, or the like, according to pre-programmed instructions.

In other implementations, there can be an angled extension 1360 that can extend from the mouse 1310 and include the touch screen 1320. The angled extension 1360 can be fixedly connected to the mouse 1310 at a specified angle or orientation. The angled extension 1360 can also be connected with a hinge 1370 or other configurable coupling to be adjustable in angle or orientation. In some implementations, the angle can be 0 degrees (horizontal), 45 degrees, 90 degrees (vertical), or the like, though any angle can be selected and supplied with the appropriate mechanical hinge or coupling. The touch screen 1320 can be incorporated into the angled extension. The touch screen 1320 can function similarly to any of the touch screens described herein. The touch screen 1320 can display any prompts, elements, graphics, images, icons, emojis, or the like. For example, the touch screen 1320 can receive user input and perform any of the operations described herein.

In yet other implementations, an alternative recessed touch screen 1380 can be incorporated into a surface of the mouse. The alternative recessed touch screen 1380 can function similar to any other touch screen including, for example, receiving user input through, for example, a finger, stylus, or the like. The alternative recessed touch screen 1380 can be recessed in a recess 1390 on the mouse 1310, or can be substantially flush with a surface of the mouse 1310. The alternative recessed touch screen 1380 and the angled extension 1360 with the touch screen 1320 can be incorporated into the mouse individually or in combination.

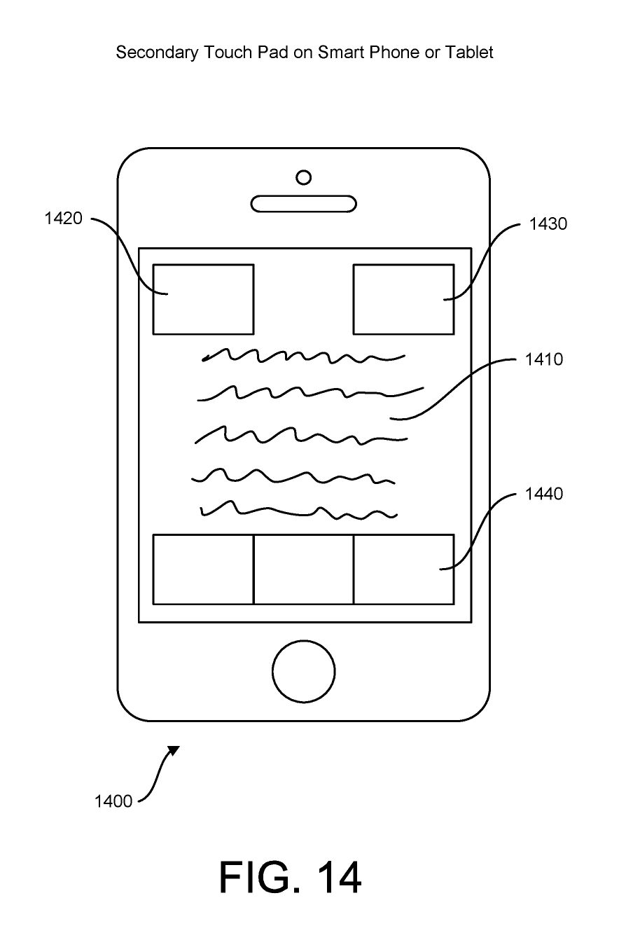

FIG. 14 is a diagram illustrating a simplified view of a secondary device 1400 as a smartphone or tablet incorporating a touch screen, in accordance with certain aspects of the present disclosure. The functionality of a mouse, among other things, can be mimicked entirely or in part on a smartphone or tablet. As shown in the example of FIG. 14, the smartphone can, on a touch screen 1410, include for example, a left key selector 1420, a right key selector 1430, one or more mode keys 1440, or the like. The touch screen 1410 can function as any touch screen described herein to display prompts, elements, or the like, and to receive user input. In some implementations, moving the secondary device 1400 can move a cursor displayed on the touch screen 1410. In other implementations, a user can move the cursor by, for example, input at the touch screen 1410, such as input from a finger or stylus. The touch screen 1410 can also display, for example, mode keys 1440. The mode keys 1440 can specify different functions or modes for the user input. In some implementations, pressing or clicking a mode key 1440 can cause, for example, an operation similar to pressing a shift key (e.g. causing a different set of prompts or elements to appear), a sketching mode to be enabled, or the like. Again, any of the functionality described herein can be implemented on the touch screen 1410 and coordinated to operate with any of the key selectors, mode keys, or the like.

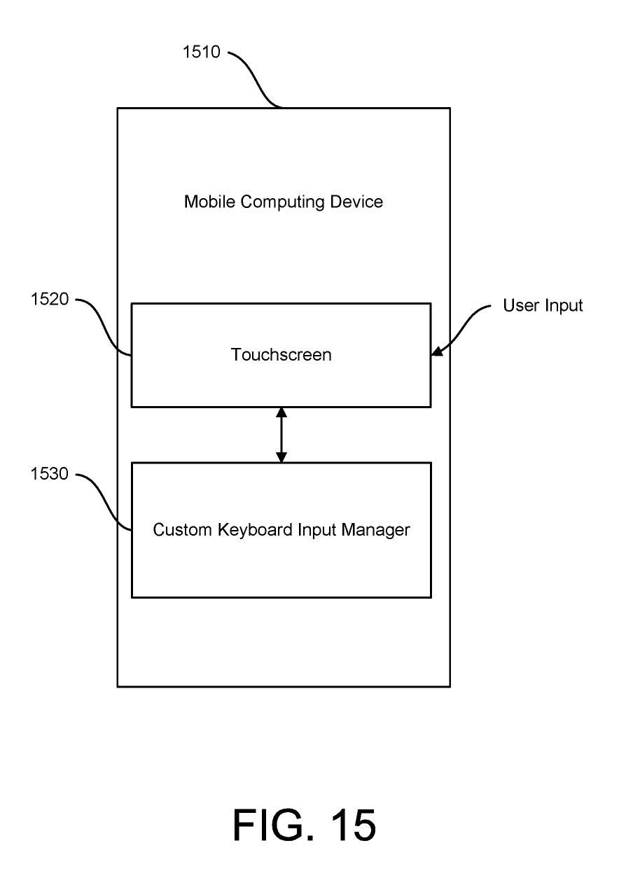

FIG. 15 is a diagram illustrating a simplified view of an exemplary system with a custom keyboard input manager 1530 running on a mobile computing device 1510, in accordance with certain aspects of the present disclosure. As described herein, the computing device or mobile computing device 1510 can receive input at a touch screen 1520. The computing device 1510 can determine the location of the input on the touch screen 1520. The input, including the location, can be locally interpreted by the custom keyboard input manager 1530 running on the computing device 1510. The custom keyboard input manager 1530 can generate commands to display any of the keyboards described herein and then apply the key selections at the computing device.

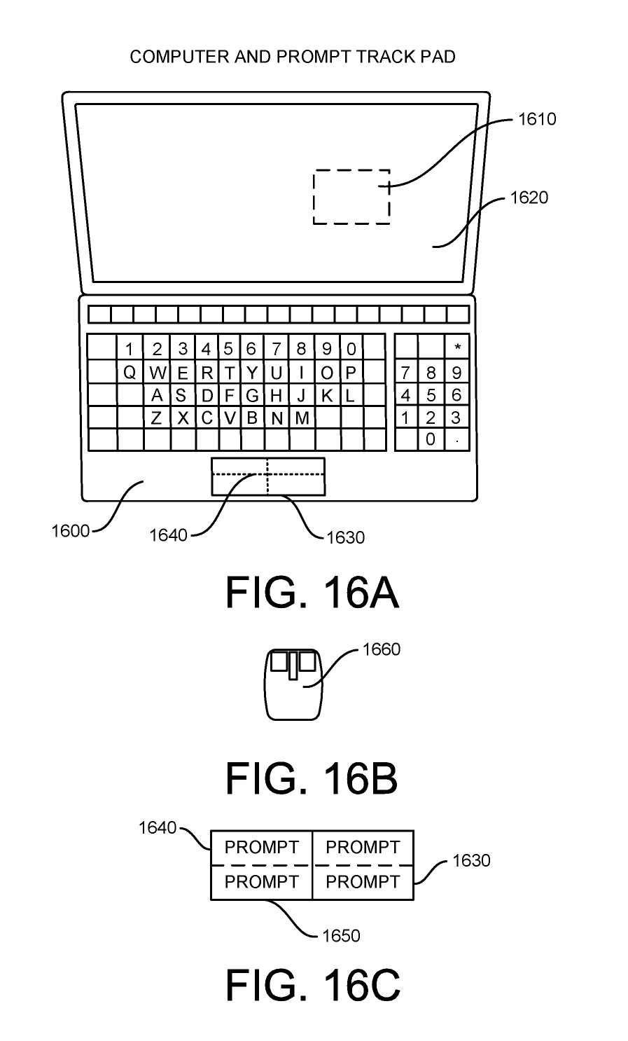

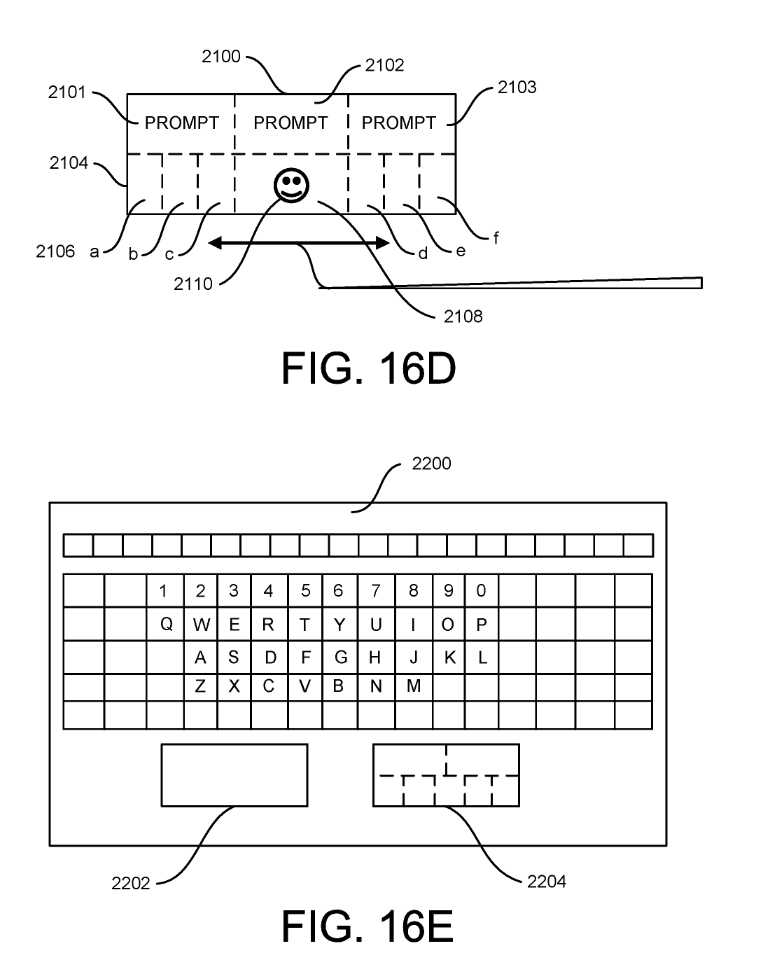

FIG. 16A is a diagram illustrating a computer 1600 with a prompt area 1610 that conforms to or approximately to the dimensions of a track pad 1630 on the computer 1630, in accordance with certain aspects of the present disclosure. FIG. 16B is a diagram illustrating a mouse 1660 that can select prompts displayed on the screen 1620, in accordance with certain aspects of the present disclosure.

A computer 1600 can display a prompt area 1610 on screen 1620. The screen 1620 can be a display device. A number of prompts can be displayed within area 1610, on screen 1620, in association with the typed content. A user can operate the track pad 1630 to place a pointer or cursor on the required prompt 1610 displayed on screen 1620. Pointing and clicking using track pad 1630 can cause that prompt to be selected and, for example, used in text or a text-entry field, displayed as an icon or symbol, or the like. In other implementations, instead of a track pad 1630, a mouse 1660 can be used to point and click on an appropriate prompt in area 1610 in order for the prompt to be used in the text.

FIG. 16C is a diagram illustrating a computer 1600 with a prompt area 1610 that is proportional or roughly proportional to the dimensions of a track pad 1630 on the computer 1630, in accordance with certain aspects of the present disclosure. In some implementations, in order to approximate track pad 1630 proportions, the prompt area 1610, can be proportionally similar to track pad 1630. In these implementations, the size of the prompt area 1610 can be larger, smaller, or the same, again with the same proportions as the track pad 1630. For example, four prompts, one being 1650 of FIG. 16C can be arranged in the four corners of area 1610, dotted line 1640 (visible or invisible) can show approximate position and size of areas utilized as buttons for entry of prompts displayed in 1610 of FIG. 16A. The above prompts one being 1650 are displayed on screen 1620 of computer 1600, of FIG. 16A, at 1610 and are arranged in the same pattern as in FIG. 16C (if four prompts are displayed).

When prompt 1650 is required to be entered, then pressing the lower left-hand (LH) corner 1650 of track pad 1630 can cause that prompt to be added into text. In other implementations, prompt 1650 can be entered into text by, for example, pressing shift then LH lower corner 1650, pressing LH lower corner 1650 directly, multiple tapping LH lower corner 1650, pressing and briefly holding LH lower corner 1650, or the like. Though this example applies to the LH lower corner, other portions of the track pad 1630 function similarly with respect to selecting prompts from the prompt area 1610. In other implementations, the track pad 1630 can be divided into any number of segments, corresponding to more or fewer prompts, (e.g. 3, 6, etc.) as long as proportions and positions are replicated between prompt area 1610 and track pad 1630 of FIG. 16A.

In yet other implementations normal use of the track pad can be retained for operations such as tracing, pointing and clicking, etc., while at the same time using the track pad to input prompts as described above. Also, track pad 1630 of computer 1600, can be in the form of a touch screen.

FIG. 16D is a diagram illustrating a display 2100 including three prompts 2101, 2102 and 2103. While three prompts are shown, in alternate implementations any number of prompts may be present. Below the prompts is an additional key row 2104, with keys 2106a, b, c, d, e and f. The central display key 2108 can ideally be larger than keys 2106a-f. The swiping key row 2104 can cause keys 2106a-f and 2108 to scroll left or right. When a key appears in the center section (i.e., where the central display key 2108 is shown), that key can be selected. In the shown example, the key can correspond to an emoji 2110 such that this emoji 2110 is displayed when that key is selected. Although an emoji 2110 is described, in alternate implementations the key can correspond to any other character, design element, and/or a function. One example of a function can be displaying a series of characters or design elements (e.g., emojis).

The display 2100 can be both a screen window and a display touch sensitive pad, which can respectively mirror the window and information on the screen. Any information or prompt can be selected by clicking on the screen and or the touch sensitive pad.

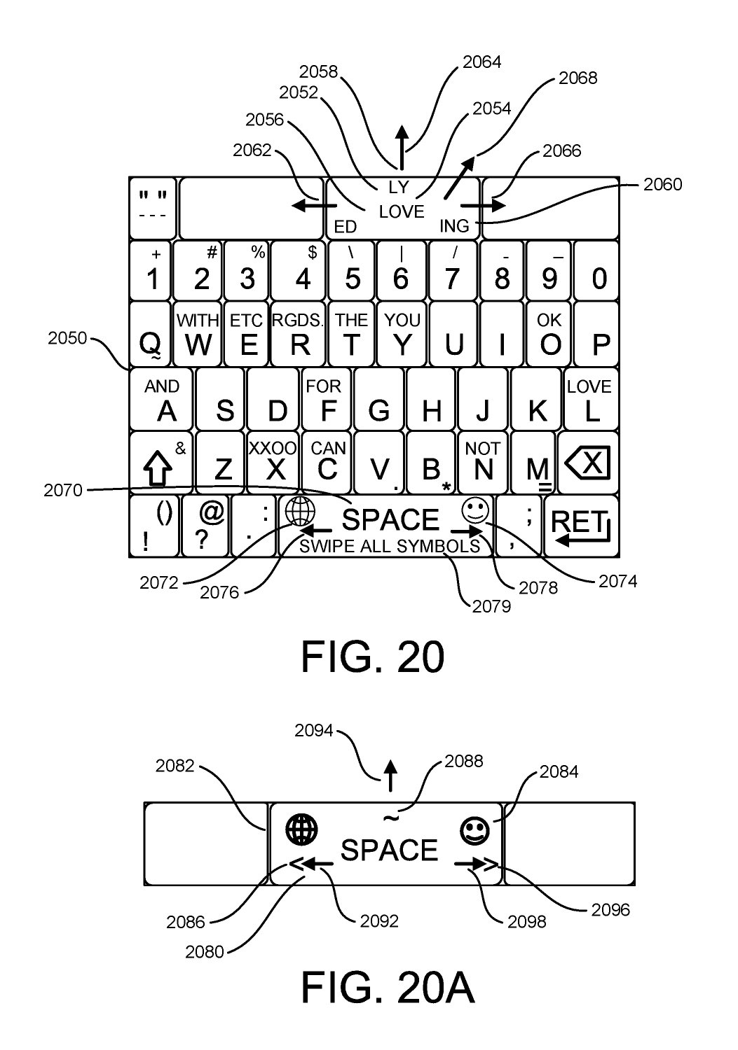

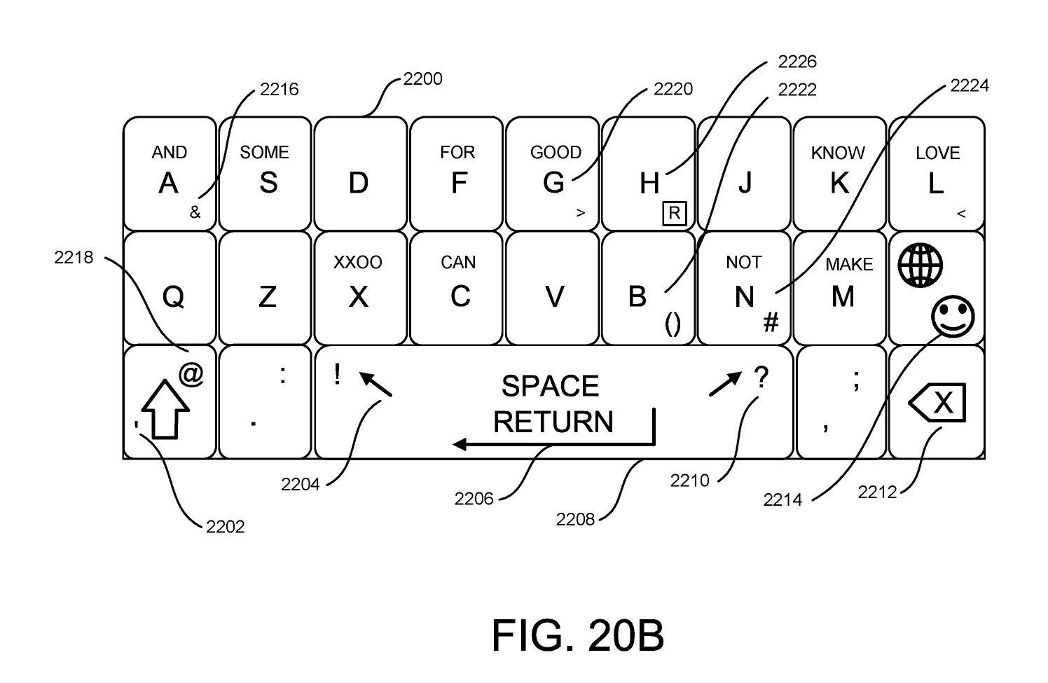

In some implementations, clicking, double clicking, triple clicking, long pressing, swiping, or the like can be used to input the selected data. Although only single prompts are shown, in alternate implementations multiple ending prompts can also be displayed and selected in similar fashion to that described with respect to FIG. 20.

FIG. 16E is a diagram illustrating a keyboard 2200 of a computing system, such as a desktop computer, a laptop computer, a tablet computer, a phablet computer, a smartphone, or any other computing device. The keyboard 2200 can have two touch pads 2202 and 2204. The first touch pad 2202 can act as a standard track pad while the second touch pad 2204 is dedicated to prompts and or scrolling keys as outlined in FIG. 16D. The second touch pad 2204 can, in one implementation, be a touch sensitive display screen. When the touch pad 2204 is a display, data on the touch screen can mirror that shown on screen 1610 shown in FIG. 16a. In the shown implementation, a user may not need to switch between operation of a track pad and a prompt pad. In alternate implementations, a user may need to switch between operation of a track pad and a prompt pad.

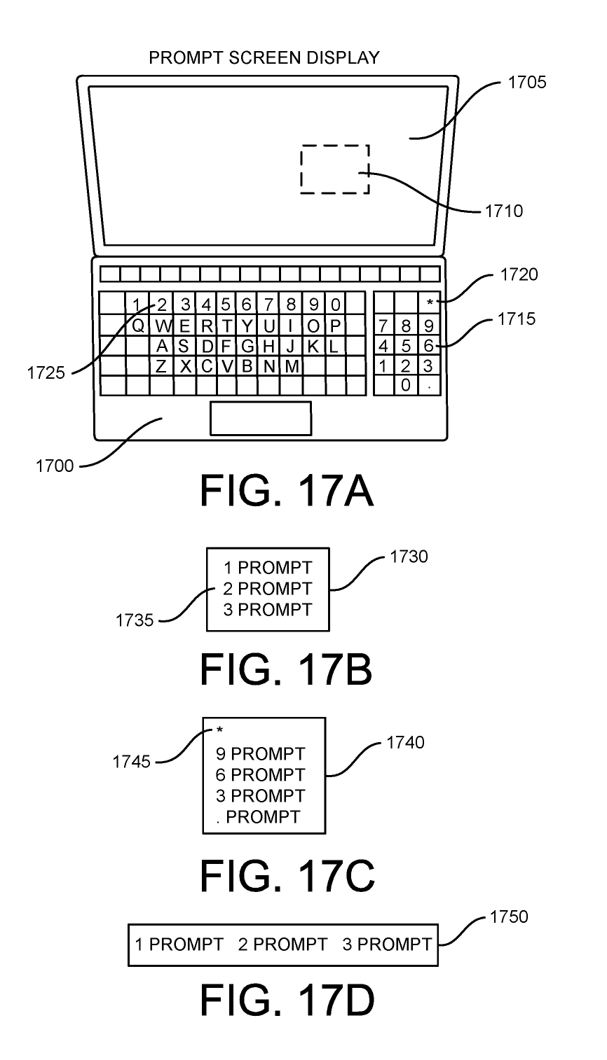

FIG. 17A is a diagram illustrating a computer 1700 with a prompt area 1710 that includes a reference to the key which triggers the prompt, in accordance with certain aspects of the present disclosure. FIG. 17B is a diagram illustrating a first example of a prompt area, in accordance with certain aspects of the present disclosure. FIG. 17C is a diagram illustrating a second example of a prompt area, in accordance with certain aspects of the present disclosure. FIG. 17D is a diagram illustrating a third example of a prompt area, in accordance with certain aspects of the present disclosure.

The features shown in FIGS. 17A-D describe implementations where a specific key can be assigned to select a displayed prompt. The displayed prompt can also include a graphical indication of which key is assigned to the particular prompt. Shown is FIG. 17 is a horizontal row of number keys 1725 as well as a vertical row of symbols and numbers 1715 and 1720. In FIG. 17B, a detail of a three prompts series numbered 1, 2 and 3, at 1730, can be displayed in prompt area 1710 of screen 1705. If prompt #2, 1735 of prompt sequence 1730 is required, operator pushes key 1725 (the “2” key) to cause prompt #310 of FIG. 3, to appear in the text. In some implementations, for the above prompt to be entered with one keystroke, the system can be configured so that horizontal numbers 1, 2, 3, etc. of keys 1725 are pre-designated to only operate the prompting. In other implementations, a shift or other toggle can be required to be pressed before key 1725 is pressed for the prompt to be entered.

FIG. 17C shows an alternative series of five prompts 1740, appearing in screen 1705, which are identified by symbols and numbers associated with vertical row 1720 of computer 1700. If the prompt 1745 designated by symbol * is required, operator can be required to push key 1720 to cause the prompt 1745 to be used in the text.

In some implementations, for the above prompt to be entered with one keystroke, the system can be configured so that vertical keys *, 9, 6, 3, of keypad 420 can be pre-designated to only operate the prompting. Otherwise, shift can be required to be pressed before key 1720 is pressed for prompt to be entered.

FIG. 17D shows a horizontal row of prompts 1750 which can be displayed in 1710 of screen 1705 of computer 1700. The horizontal rows can be an alternative to the vertical rows of FIGS. 17B and 17C. In other implementations, any number or types of prompts using any combination of pre-determined keys can be used. Also, dedicated keys can be used for entering prompts. Furthermore, voice can be used to input the above prompts, by identifying each prompt by direct prompt or via a headset. The foregoing shows how, simply and quickly, a standard computer can be employed to display and enter prompts with minimum or no hardware changes.

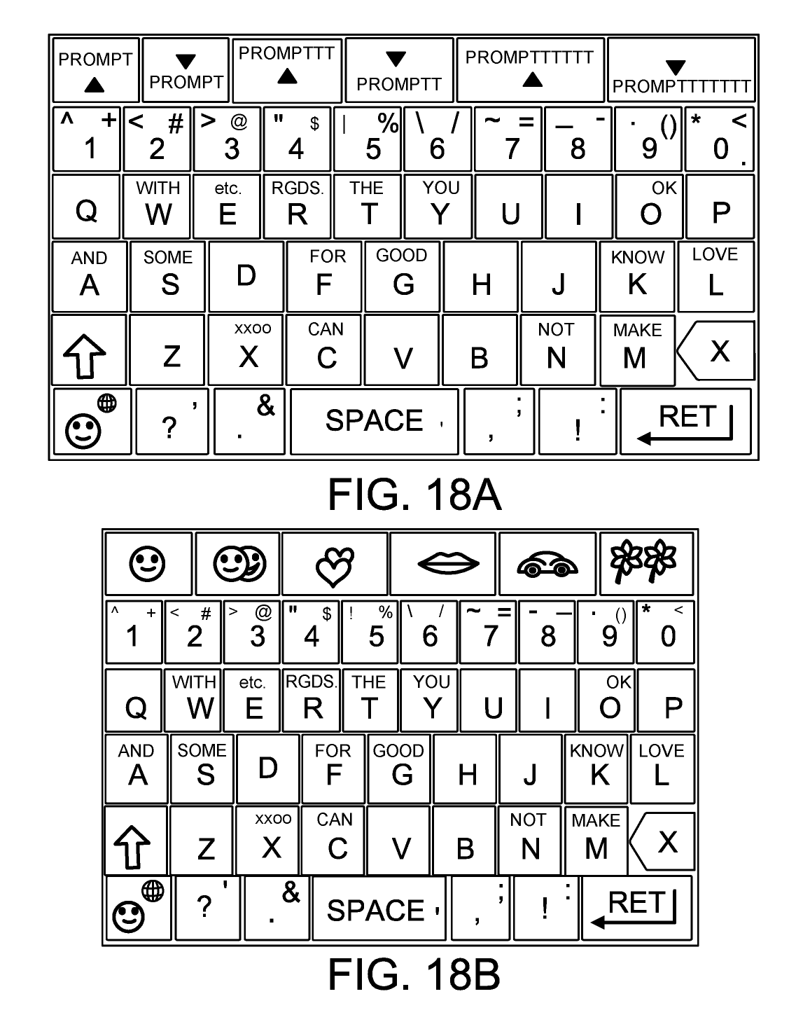

FIG. 18A is a diagram illustrating a virtual keyboard with a multiple prompt area, in accordance with certain aspects of the present disclosure.

The prompt row can have two smaller areas in each prompt area. In some implementations, the two smaller areas can be arranged in a vertically divided configuration, and in other implementations the smaller areas can be divided in horizontal configurations. In other implementations, when a prompt displays text in the singular form (e.g. “kind,” “shoe,” “dollar,” etc.) then such a prompt can be selected by a single click. When a double-click is detected on this prompt, the selection can conform to the plural of the specified prompt (e.g. “kinds,” “shoes,” “dollars,” etc.). Prompts in FIG. 18A can be arranged alternately above and below a key center line to allow long prompt words to overlap. This can enable additional prompts to be displayed in a more compact space.

Also, in the implementation shown in FIG. 18A, row 2 can display a primary, secondary, and tertiary element. Here, a single click can select the primary element, a press and hold can select the secondary element, or pressing shift and then the key can select the tertiary element.

FIG. 18B is a diagram illustrating a virtual keyboard with an alternate prompt row, in accordance with certain aspects of the present disclosure.

Similar to other implementations described herein, the virtual keyboard can display a collection of key rows that can include a prompt row. The prompt row can be dual-prompt row, displayed in response to user-input, or a default prompt row, displayed automatically and without user-input.

In some implementations, as shown in FIG. 18B, the prompt row can be, for example, an emoji row that can be displayed in response to user-input, for example when the space bar (or other key) is clicked, double-clicked, or the like. As before, the configuration of emojis or other prompts can be configured by the user to correspond to a desired key or sequence of user input.

In other implementations, the emoji row can be a default row which can remain displayed automatically without a key being pressed. When a specified key is pressed, then the dual-prompt row 1b can be displayed in place of emoji row.

In other implementations, which can apply to any of the other implementations described herein, one or more keys can cause a color selection element to be rendered on a display. The color selection element can be, for example, a color palette, color wheel, an array of colored icons, or the like. The color selection element can receive user input, for example, clicks, double clicks, or the like, that cause a selected color to be applied to existing characters or to the background of existing characters. In other implementations, the color selection can be applied to subsequent text or backgrounds. In yet other implementations, the selected color can be highlighted or otherwise graphically indicated on the color selection element. The key causing the color selection element to be displayed can be a custom or dedicated key (i.e. not a standard keyboard key) or an existing key, for example, a shift key, control key, or the like. The command to apply the color from the color selection element can be, for example, a single click on the corresponding portion of the color selection element, a double-click, a shift press and click, selection with a mouse or stylus, or the like. The mapping for the command can be edited by a user similar to the other methods of configuring the mappings for other functions of the keyboards described herein.

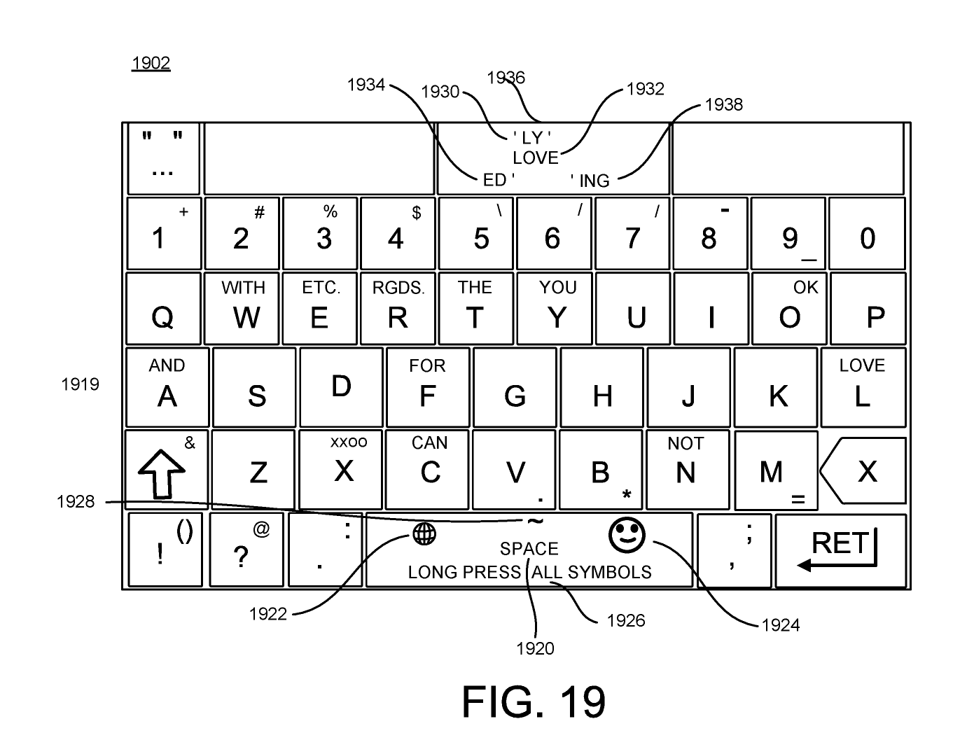

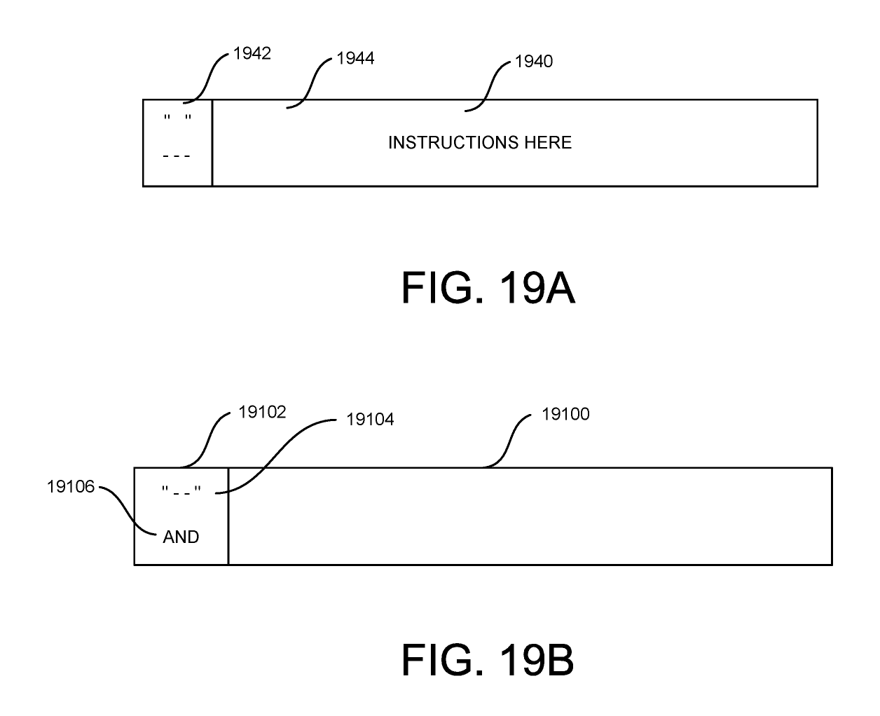

FIGS. 19, 19A, 19B, 20, 20A, 20B, 21, 21A, and 21B are diagrams illustrating aspects of a keyboard on a smartphone. These aspects can advantageously allow a user to quickly and easily input data on a smartphone, especially given the usual requirement of a smartphone to change screens for data other than text, such as at least some symbols. These aspects also allow a utilization of the space key for additional symbols. These aspects further allow a user to utilize a single prompt key to be able to quickly enter a word as well as additional verbs, adjectives, and the like that are derivatives of that word or similar words. Any elongated key, such as a space bar/key or any other key, may be used to quickly input multiple various symbols or words in a minimal space without requiring extra screens. These aspects can further allow the space key or the prompt keys to automatically deliver messages or instructions without the need for extra keys or screens. The keyboard can have a dedicated key to avoid unwanted auto correction. These aspects can provide a smart phone keyboard where space is limited so that typing errors between the space key and the bottom letter keys, which are common, can be minimized. While a smartphone is described, in alternate variations these diagrams and implementations can be specific to any other computing device, such as a desktop computer, a laptop computer, a tablet computer, a phablet computer, or any other computing device.

FIG. 19 illustrates one view of a keyboard 1919 according to at least some implementations consistent with the current subject matter. The keyboard 1902 can be a keyboard for a smart phone, and can include at least some elongated keys. Each of some or all of the elongated or any key can be used to enter multiple inputs. The keyboard 1919 can include a space key 1920, and can be used to insert a space when clicked once and for a period when clicked twice. The functionality of the space key 1920 can be expanded by associating additional symbols—additional symbols 1922 and 1924, which can be added to each side or corner of this space key 1920—with additional activity with the space key 1920. In one implementation, only an authorized user—for example, someone with authenticated access, such as username and password, to access a microcontroller controlling the operations of the keyboard 1919—can expand the functionality of a key. In an alternate implementation, a user of the keyboard may be granted permission for expanding the functionality of one or more keys. The additional activity for the symbol 1922 can be clicking the left side of the space key 1920 for an extended period of time (that is, time beyond a threshold time). The additional activity for the symbol 1924 can be clicking the right side of the space key 1920 for an extended period of time (that is, time beyond a threshold time. The space key 1920 can further include the symbol 1928, which can be input when the user clicks a corresponding portion (e.g., center) of the space key 1920 for an extended period of time (that is, time beyond a threshold time).

The symbols 1922 and 1924 can additionally or alternately be input by swiping on the left and right sides, respectively, of the space key. While specific symbols 1922, 1924, and 1928 are shown, in other implementations any additional and/or alternate symbols can be used. The space key 1920 can further include a note 1926 that can provide an instruction to a user as to how the user can operate the space key 1920 to input symbols 1922, 1924, 1928, and/or any other symbol on any other key of the keyboard 1919.

The keyboard 1919 can include a prompt key 1930. The prompt key 1930 can shows a prompt 1932. This prompt 1932 can be input by a single click of any area of prompt key 1930. The prompt key 1930 can include alternative endings 1934, 1936, and 1938. The prompt 1932 can be input by a single click on the prompt key 1930. An “s” can be added or removed from the prompt 1932 by double clicking anywhere on prompt key 1930. Three or more alternative endings 1934, 1936 and 1938 of the prompt 1932 can be input by pressing or long pressing (i.e., press for a time more than a threshold value of time) right hand side, left hand or center of the prompt key 1930 to respectively input endings 1934, 1936, and 1938. In this mode, the prompt key 1930 can be divided into three segments for pressing or long pressing. While a long press is described here, a swipe can alternately be used to enter various elements. The swipe feature, which is described in greater detail below, although may work better for larger keys (e.g., space bar) than smaller keys, as larger keys offer more surface area on which the user can swipe. In one implementation, all keys can employ swiping, and the direction of the swipe can further differentiate as to which element is inserted into the text.

FIG. 19A illustrates an alternative prompt key row 1940 of the keyboard 1919. The prompt key row 1940 can include a key 1942 and a message 1944. The key 1942 can be minimized to save space. The key 1942 can be pressed after an uncommon word is entered, and when the user desires avoiding auto correction. The key 1942 can be pressed before or after a space to revert back to what was actually typed. The message 44 can be automatically displayed at various times, without need for additional screen space and/or user input. Any auto corrected word can be selected, and the key 1942 can be activated to restore the word (that is, obtain the original word without the auto-correction).

FIG. 19B illustrates another alternative prompt key row 19100, with a key 19102 on the left. While the key 19102 is described on the left of the prompt key row 19100, in alternative implementations the key 19102 can be at any other location on the prompt key row 19100. The key 19102 can be used for a dual purpose. One such purpose can be to input prompt 19106 by a single click of the key 19102. The other such purpose can be to reverse the auto correct referenced by 19104 by double tapping the key 19102, so that the user can quickly enter either a prompt or an auto correct reversal. In one implementation, the reversal of the auto correct can also be achieved by a long press. Alternately, the reversal of the auto correct can be achieved by double clicking 102 even after one or more spaces.

FIG. 20 illustrates a prompt keyboard 2050, including prompt key 2052 and prompt word 2054. In this implementation, a user can be allowed to input the primary prompt 2054 by a single click anywhere on key 52. Additionally, double clicking anywhere on the prompt key 2052 can input a plural of the word 54 or remove an “s” from a plural word to make the word singular. The key 2052 can include alternate endings 2056 and 2060 of the primary word 2054. While two endings 2056 and 2060 are shown, in other implementations any number or types of endings can be used. The prompt word 2054 with ending 2056 can be input by swiping the key 2052 to the left in the direction of the arrow 2062. The arrow 2062 may not be a physical button on the keyboard, and just shows the direction in which the swiping on the key 2052 must be performed to enter the prompt word 2054 with ending 2056. The prompt word 2054 with the ending 2058 of the key 2052 can be inputted by swiping key 2052 upwards shown by arrow 2064. The prompt word 2054 with ending 2060 can be input by swiping the key 2052 to the right in the direction of the arrow 2066. The arrows 2064 and 2066 may not be a physical buttons on the keyboard, and just show the direction in which the swiping on the corresponding key must be performed to enter the prompt word 2054 with the corresponding ending. The prompt word 2054 with a combination of the endings 2058 and 2060 can be input by swiping the key 2052 diagonally up and to the right as shown by arrow 2068. The arrow 2068 may not be a physical button on the keyboard, and just shows the direction in which the swiping on the key 2052 must be performed to enter the prompt word 2054 with a combination of the endings 2058 and 2060. In this way, a single prompt key can be employed to quickly and easily input one basic prompt word as well as additional derivative prompt words. Note that the above-noted swiping entry method can also be employed with similar words in the prompt area, such as the, this, that, these, those, and/or the like.

Further, the prompt keyboard 2050 can include a space bar/key 2070, which can facilitate input using swiping of the space bar/key 2070 and/or clicking/pressing of the space bar/key 2070 for a long time (i.e., time more than a threshold). The space key 2070 can have symbols 2072 and 2074. While symbols 2072 and 2074 are shown, in alternate implementations the space key 2070 can have any number of symbols. When a user swipes the key 2070 to the left, as shown by the arrow 2076, symbol 2072 can be input. The arrow 2076 may not be a physical button on the keyboard, and just shows the direction in which the swiping on the key 2070 must be performed to enter the symbol 2072. When a user swipes the key 2070 to the right, as shown by the arrow 2078, symbol 2074 can be input. The arrow 2078 may not be a physical button on the keyboard, and just shows the direction in which the swiping on the key 2070 must be performed to enter the symbol 2074. These extra symbols can thus be input without interfering with the single clicking or double clicking anywhere on the space bar 2070. The message ‘Swipe for all Symbols’ 2079, or another similar message, can be added to the key 2070.

FIG. 20A illustrates an alternative to the space bar/key 2070 that can have additional symbols 2086, 2088 and 2090. The symbol 2086 can be input by swiping the space bar 2070 to the left, as shown by arrow 92. The symbol 2088 can be input by the swiping the space bar 2070 upwards, as shown by the arrow 2094. The symbol 2096 can be entered by swiping the space bar 2070 to the right, as shown by the arrow 98. In this manner, the space bar 2080 can be used to quickly and easily input five additional symbols without any extra space or without interfering with space key 2080′s normal function and without the need to change any screen. The arrows shown may not be physical buttons on the keyboard, and just show the direction in which the swiping on the corresponding key must be performed to enter a corresponding element.

Symbols 2082 and 2084 may also be input by swiping diagonally upward to the left for symbol 2082 or diagonally upwards to the right for symbol 2084. The symbols 2082 and 2084 can additionally be input by swiping diagonally upward to the left for symbol 2082 or diagonally upward to the right for symbol 2084.

FIG. 20B illustrates a lower section 2200 of a smart phone keyboard, specifically lower row 2202, with back key 2212 in place of the return key of FIG. 20 in order to advantageously include an extra key 2214. Here, the return key is placed together with the space key 2208. The space key 2208 includes symbols 2204 and 2210. The space key 2208 can operate by a single click. The return key can operate by swiping the space key 2208 left or right in a horizontal manner. The symbols 2204 and 2210 can be input by swiping diagonally left or diagonally right, respectively. Alternatively, the symbols 2204 or 2210 can be input by an extended press on the left or right of the space key 2208. In this manner, data can advantageously be input quickly with the max sized keys so as to avoid typing errors. Additional or alternate symbols can be employed by extended pressing of these symbols and swiping others.

The lower section 2200 of the keyboard can further include keys 2216, 2218, 2220, 2222 and 2224. Each of the keys 2216, 2218, 2220, 2222 and 2224 can have an associated symbol associated with the first letter of the wording of the symbol. For example, the key 2216 can have the wording “AND,” and also the letter “A” (which is the first letter of “AND”) and the symbol “&” (which signifies “AND”). Similarly, the key 2224 can have the wording “NOT,” and also the letter “N” (which is the first letter of “NOT”). In addition, the key 2216 can include the symbol “#” for NUMBER, which is another common word that begins with the letter “N.” In a similar manner, the key 2222 includes the letter “B” as well as bracket symbols “(” and “)”, which stand for BRACKETS, which starts with the letter “B.” Similarly, the key 2226 can include the letter “H” and the symbol for HOME, which begins with the letter “H.” Such configuration of the keys advantageously allows an operator of the keyboard to easily find a symbol that is associated with the first letter of the word for that symbol when desired. Multiple clicking, long pressing, or swiping on the key with a symbol can result in execution of an associated function, such a display of the home page when such operation(s) are performed by the operator on the key 2226.

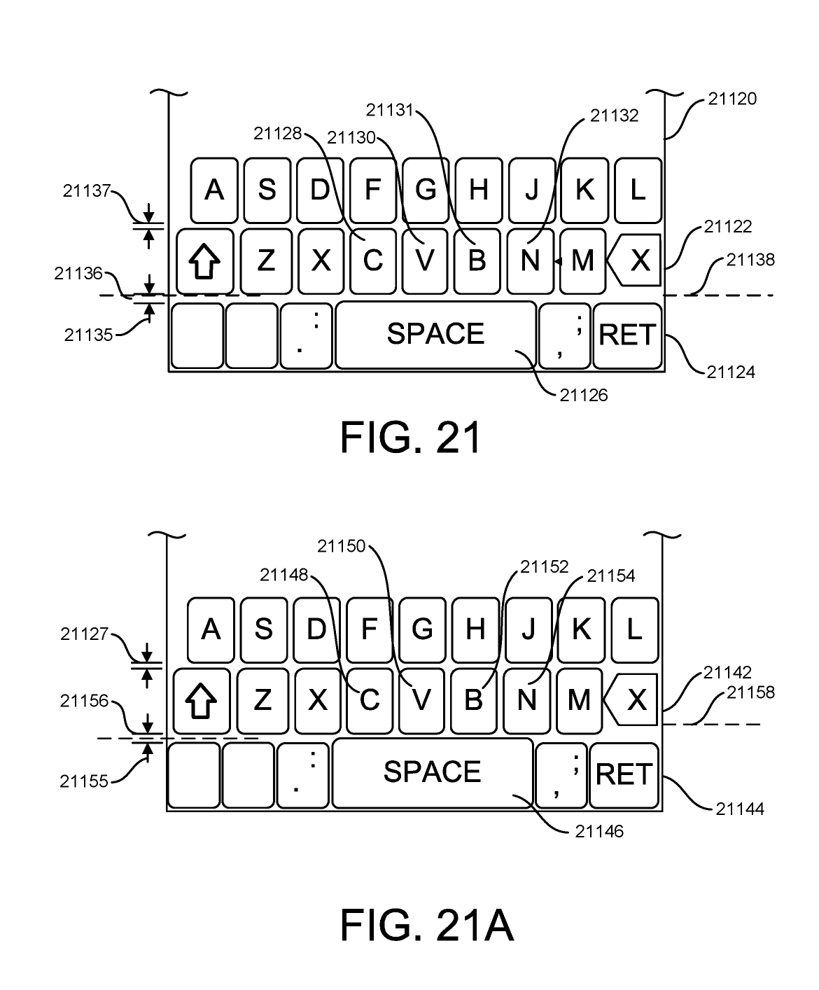

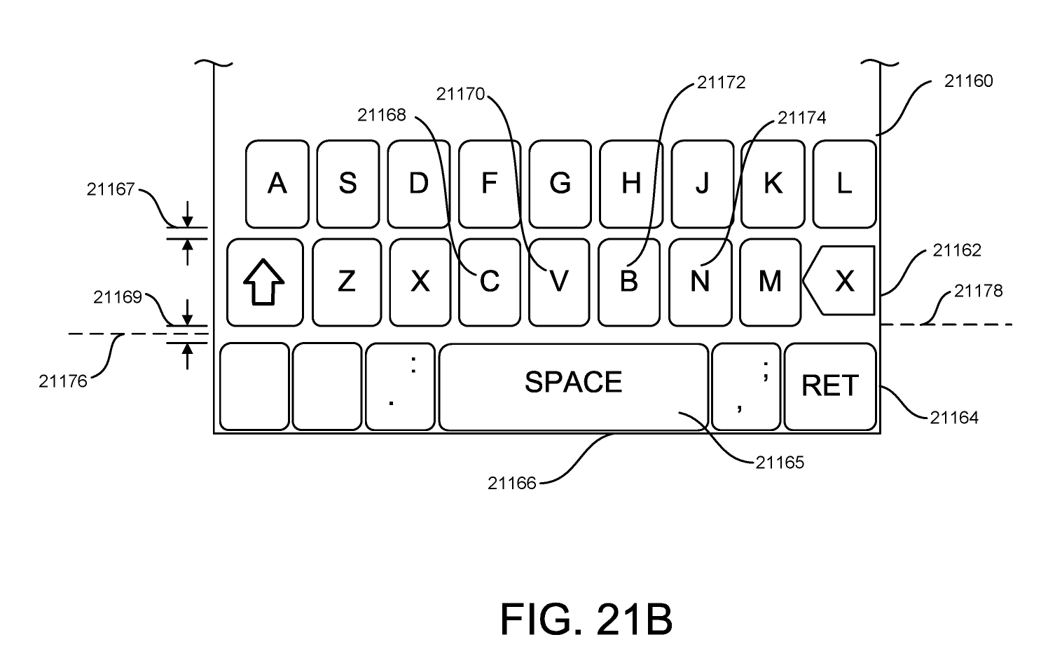

FIG. 21 illustrates a lower section 21120 of a smart phone. While a smart phone is described, in alternate implementations any other computing device can be used such as a desktop computer, a laptop computer, a tablet computer, a phablet computer, or horizontally left or the like. The lower section 21120 can include two rows 21122 and 21124. The row 21122 can have keys with letters C, B, V, N—as indicated using reference numerals 128, 130, 132, and 134, respectively—and so on. The row 21124 can be below the row 21122, and can include a space key 21146. While a specific arrangement of letters is shown in each row, in alternate implementations any other arrangement can be possible.

Vertical spacing between keys 21137 is conventionally uniform, and the active area for each key is the centerline 21136 between each key. The active area can refer to the area which a user can press to access a particular key, and usually the boarder for the active area is half way to the next key. For example, pressing above the line 21136 can cause the key above the centerline 21136 (e.g., keys above the space key 21126) to be input, and pressing below the centerline 21136 can cause the key below the center line 21136 (e.g., the space key 21126) to be input. In the implementation shown in FIG. 21, however, the active area of the space key 21126 is moved upward so as to advantageously enlarge the active area for the space key 21126, which is often one of the most used keys. This can advantageously reduce, minimize, or prevent typographical errors.

When a user is typing quickly, it can be common for the user to strike one of the keys 21128, 21130, 21132 or 21134 instead of space key 21126, thereby causing a typing error (e.g., typographical error) as the space key 21126 is typically the same height as row 21124. Here, this deficiency is cured by having the space key 21126 as being higher than adjacent keys of row 21124 and above the centerline 21136. This can prevent a user from inadvertently entering a letter above the space key 21126 when intending to enter the space key 21126.

FIG. 21A illustrates a smart phone keyboard 21140 with uniform vertical separation 21155 and 21157 between lower rows 21142 and 21144. The row 21142 can include keys 21148, 21150, 21152 and 21154 corresponding to letters C, B, V, N, respectively, which are above the space key 21146 below. The spacing 157 between the row 21142 and the row above it can be same or almost same as the spacing 155 between the row 21142 and the row 21144.

The active area key line (that is, line that determines which keys are activated upon selection of keys above or below it) 21158 can be moved above the normal center line 21156. When a user clicks the bottom of keys 21148, 21150, 21152 and 21154, the space key can be activated, which can be advantageous in some implementations for minimizing or preventing typographical errors. In other implementations, the center line 158 can be moved higher or lower with respect to the line 21156 to minimize or reduce typographical errors.

FIG. 21B illustrates another smart phone lower keyboard 21160. While a smart phone keyboard is described, in alternate implementations the keyboard can be of any other computing device such as a desktop computer, a laptop computer, a tablet computer, a phablet computer, or the like. The keyboard 21160 can include a letter row 21162 and a row 21164 that are collectively arranged to prevent typographical errors when a user enters the space key/bar 21166. The spacing 21167 can be less than spacing 21169. The active key line (that is, line that determines which keys are activated upon selection of keys above or below it) 21178 can be above the normal center line 21176, which are usually the middle line within the spacing 21169. Clicking anywhere in space 21169 will enter a space rather than execute the functionality of a key above the top portion 21165 of the space bar 21166. In this manner, when the user clicks the top portion 21165 of the space bar 21166, a space will be input rather than a typographical error with letters C, B, V, or N by inadvertent clicks of keys 21168, 21170, 21172 or 21174, respectively.

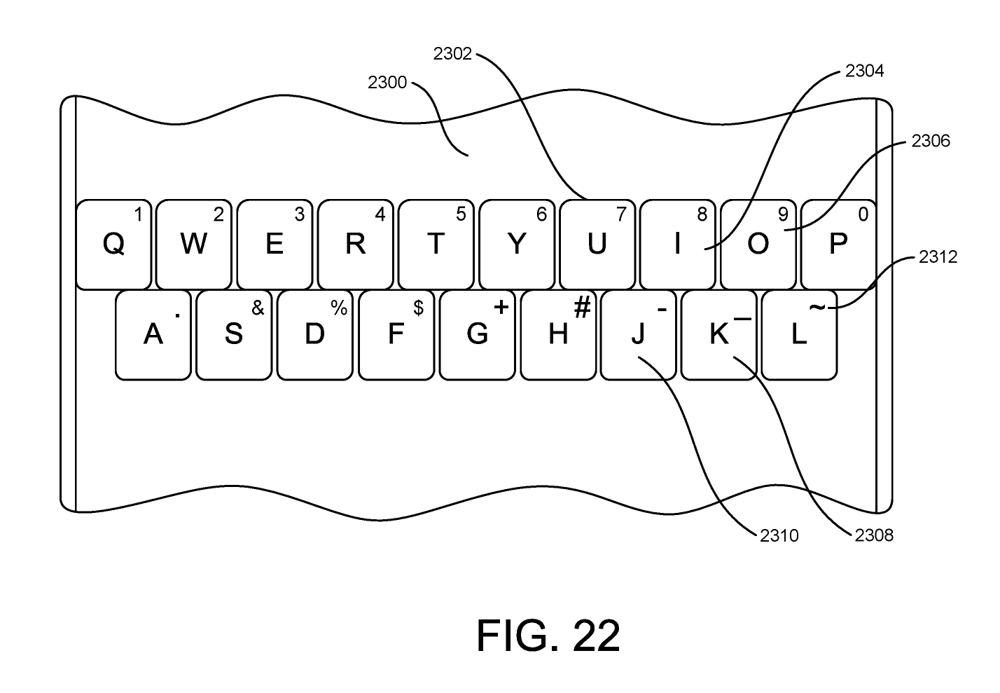

FIG. 22 illustrates two typical rows 2302 and 2308 of a compact smart phone or tablet keyboard 2300. The row 2302 can include letters 2304 with secondary numbers 2306. The second row 2308 can include letters 2310 and symbols 2312. The letters of the rows 2302 and 2308 can be entered by clicking the corresponding key while numbers 2306 and symbols 2312 can be entered by swiping the corresponding key. In this manner, the keyboard can be compact, which is beneficial for a small computing device such as a phone or a tablet; switching between keyboard screens is prevented for convenience of a user as well as speed; and speed at which the data can be input is faster as keyboard screens do not need to be switched to access various characters.

In one implementation, the keyboard can include a plurality of rows with letters as a primary character. Each row of the plurality of rows with letters as the primary character can have nine or less number of keys to maximize the key spacing in order to avoid typographical errors.

In some implementations, the graphical user interface can display the element when the element is input by the corresponding preset action (e.g., when a key is pressed or clicked) by the user, rather than waiting for an end of the action (e.g., lifting of a finger by the user from a key including the element). In alternate implementations, however, the graphical user interface can display the element after waiting for an end of the action (e.g., lifting of a finger by the user from a key including the element).

The present disclosure contemplates that the calculations disclosed in the implementations herein may be performed in a number of ways, applying the same concepts taught herein, and that such calculations are equivalent to the embodiments disclosed.

Further, words may often be misspelt when typing on small smartphone keyboards. The user frequently does not realize the spelling error until much later, and the prompts for that correction have already disappeared by that time. To overcome this, one or more of the following can occur: (1) when a spelling error occurs, the incorrect word can be made to flash while the prompt is displayed; (2) when a spelling error occurs, the prompted word in the prompt can be made to flash, (3) when a spelling error occurs, a specific (e.g., preset) alarm or sound can be activated, and (4) when a spelling error occurs, a window can appear (e.g., pop-up) near the text. In this manner, the user can be alerted to the error as soon as the error occurs so that the user can respond with the appropriate prompt rather than miss the error as well as the correcting prompts.

Various implementations of keyboards are described herein. Several keys of the keyboards are associated with several functionalities. The functionality of a key can be enabled by one or more microcontrollers operably coupled to each key and/or the keyboard. At least some or all of the microcontrollers can include one or more programmable processors. In one implementation, the microcontroller can be embedded in the keyboard. In an alternate implementation, the microcontroller can be remote to and communicatively coupled with the keyboard via a physical connection (e.g., a wired connection) or a wireless connection. The wireless connection can be a connection via a local area network, a wide area network, internet, intranet, a BLUETOOTH network, infrared network, any other network, and/or any combination thereof. The one or more microcontrollers can further be connected to the prompt area on the keyboard. The one or more microcontrollers can also be connected to any other display device that is configured to output the input received from the keyboard.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” (or “computer readable medium”) refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” (or “computer readable signal”) refers to any signal used to provide machine instructions and/or data to a programmable processor. The machine- readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of or “one or more of may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, computer programs and/or articles depending on the desired configuration. Any methods or the logic flows depicted in the accompanying figures and/or described herein do not necessarily require the particular order shown, or sequential order, to achieve desirable results. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. The implementations described above can be directed to various combinations and subcombinations of the disclosed features and/or combinations and subcombinations of further features noted above. Furthermore, above described advantages are not intended to limit the application of any issued claims to processes and structures accomplishing any or all of the advantages.

Additionally, section headings shall not limit or characterize the invention(s) set out in any claims that may issue from this disclosure. Specifically, and by way of example, although the headings refer to a “Technical Field,” such claims should not be limited by the language chosen under this heading to describe the so-called technical field. Further, the description of a technology in the “Background” is not to be construed as an admission that technology is prior art to any invention(s) in this disclosure. Neither is the “Summary” to be considered as a characterization of the invention(s) set forth in issued claims. Furthermore, any reference to this disclosure in general or use of the word “invention” in the singular is not intended to imply any limitation on the scope of the claims set forth below. Multiple inventions may be set forth according to the limitations of the multiple claims issuing from this disclosure, and such claims accordingly define the invention(s), and their equivalents, that are protected thereby.

Because of the high-level nature and complexity of the selections and methods described herein, including the multiple and varied combinations of different calculations, computations and selections, such selections and methods cannot be done in real time quickly, or at all, by a human. The processes described herein rely on the machines described herein.

What is claimed is:

1. A keyboard comprising:
a plurality of keys, at least one key of the plurality of keys including a primary element and a secondary element of a plurality of elements; and
a prompt area to display one or more characters associated with at least one element of the plurality of elements.

2. The keyboard of claim 1, wherein the at least one key further includes a tertiary element of the plurality of elements.

3. The keyboard of claim 2, wherein the at least one key further includes one or more additional elements of the plurality of elements.

4. The keyboard of claim 1, wherein each element of the plurality of elements is input when a corresponding action specific to the element is performed on the at least one key.

5. The keyboard of claim 4, wherein the corresponding action is one or more of: a single click of the at least one key, a double click of the at least one key within a preset time-period, a triple click of the at least one key within another preset time-period, a simultaneous click of the at least one key and a shift key within the plurality of keys, a pressing of the at least one key for more than a preset amount of time, a swipe over the at least one key in any direction, a swipe over the at least one key in a preset direction, a click on a specific portion of a trackpad communicatively coupled to the keyboard, and a selection on an input device communicatively coupled to the keyboard.

6. The keyboard of claim 5, wherein the corresponding action is dependent on an amount of physical area occupied by the at least one key.

7. The keyboard of claim 4, wherein the one or more characters displayed in the prompt area differ based on a speed of the corresponding action.

8. The keyboard of claim 4, wherein the corresponding action specific to the element is changeable.

9. The keyboard of claim 1, wherein:
the secondary element is a word that begins with the primary element; or
a textual characterization of the secondary element begins with the primary element.

10. The keyboard of claim 1, wherein the one or more characters displayed in the prompt area include a plural of the word when the word is singular, and a singular of the word when the word is plural.

11. The keyboard of claim 1, wherein the one or more characters displayed in the prompt area include one or more alternates to the secondary element.

12. The keyboard of claim 1, wherein the one or more characters displayed in the prompt area include at least one character preselected by a user as at least one favorite character.

13. The keyboard of claim 1, wherein:
the plurality of characters displayed in the prompt area include at least one of: one or more words, one of more phrases, one or more sentences, one or more symbols, one or more icons, and one or more pictographs of faces, objects, and symbols;
the one or more icons include one or more emoticons; and
the one or more pictographs include one or more emojis.

14. The keyboard of claim 1, wherein the keyboard is a part of one of: a watch, a phone, a phablet computer, a tablet computer, a laptop computer, and a desktop computer.

15. The keyboard of claim 1, wherein the prompt area displays the one or more characters in one or more rows.

16. The keyboard of claim 15, wherein the one or more rows are two or more rows.

17. The keyboard of claim 1, wherein the one or more characters displayed in the prompt area include: a word specific to the at least one element, and endings for the word to create at least one of a verb, an adjective, and another derivative of the word.

18. The keyboard of claim 1, wherein an active area of at least some frequently used keys of the plurality of keys is larger than active area of other keys of the plurality of keys.

19. The keyboard of claim 18, wherein the at least some frequently used keys are preset keys including a space key.

20. The keyboard of claim 1, wherein the prompt area generates a notification when a typographical error occurs, the notification including one or more of: a first flash in the prompt area highlighting a location of the typographical error, a second flash in the prompt area, an alarm, and a pop-up window.

21. A system comprising:
a keyboard comprising a plurality of keys and a prompt area, at least one key of the plurality of keys including a plurality of elements, each element of the plurality of elements being input when a corresponding preset action of a plurality of actions is performed by a user, the prompt area configured to display one or more characters related to the element of a plurality of characters;
a memory communicatively coupled to the keyboard, the memory configured to store a mapping between the plurality of elements along with the plurality of actions and the plurality of characters; and
a microcontroller communicatively coupled to the keyboard and the memory, the microcontroller configured to:
receive, from the keyboard, data characterizing an action performed by the user and an identification of a key on which the action is performed;
identify, based on the mapping, the one or more characters that are to be displayed on the prompt area; and
transmit, to the prompt area, the one or more characters.

22. The system of claim 21, further comprising an output device that outputs the element input by the corresponding preset action by the user.

23. The system of claim 22, wherein the output device is a graphical user interface configured to display the element.

24. The system of claim 22, wherein:
the memory is configured to store a mapping of a plurality of abbreviations and a full word or phrase of each abbreviation; and
the output device is configured to output the full word or phrase of a specific abbreviation of the plurality of abbreviations when a user performs another corresponding action on keys corresponding to characters in the specific abbreviation.

25. The system of claim 24, wherein the corresponding preset action is one of: a single click, a double click within a preset time-period, a triple click within another preset time-period, a simultaneous click with a shift key within the plurality of keys, a pressing of the key for more than a preset amount of time, a swipe over the key in any direction, a swipe over the key in a preset direction, a click on a specific portion of a trackpad communicatively coupled to the keyboard, and a selection on an input device communicatively coupled to the keyboard.

26. The system of claim 21, wherein the memory, the microcontroller, and the keyboard are embedded within a single device having a single physical housing.

27. The system of claim 21, wherein:
the memory is communicatively coupled to the keyboard via a first communication network;
the microcontroller is communicatively coupled to the keyboard via a second communication network; and
the microcontroller is communicatively coupled to the memory via a third communication network.

28. The system of claim 21, wherein a single key is used for the space and enter functionalities.

29. The system of claim 21, wherein the keyboard comprises a plurality of rows with letters as a primary character, each row of the plurality of rows with letters as the primary character having nine or less keys.

30. The system of claim 23, wherein the graphical user interface displays the element when the element is input by the corresponding preset action by the user.

31. The system of claim 21, wherein the microcontroller is configured to display a pop-up window displaying the one or more characters related to the element.

32. The system of claim 31, wherein the element is an emoji.
